(19) United States
(12) Patent Application Publication
(10) Pub. No.: US 2025/0021769 A1
(43) Pub. Date: Jan. 16, 2025

(54) COMPUTER TASK GENERATION USING A LANGUAGE MODEL

(71) Applicant: Google LLC, Mountain View, CA (US)

(72) Inventors: Thomas William Buckley, Brooklyn, NY (US); Douglas Stockwell, Ryde (AU); Robert Mickle, Breckenridge, CO (US); Tony Butler-Yeoman, Sydney (AU); Lauren Monique Commeignes, Marrickville (AU); Adrianus Antonius Johannes Oerlemans, Lane Cove (AU); Aedan Donald Pope, Margaret River (AU); Nikolas Bowe, Como (AU)

(21) Appl. No.: 18/771,633

(22) Filed: Jul. 12, 2024

Related U.S. Application Data
(60) Provisional application No. 63/513,440, filed on Jul. 13, 2023.

(51) Int. Cl. G06F 40/40; G06F 9/451; G06F 40/205; G06F 40/30

(52) U.S. Cl. CPC G06F 40/40; G06F 9/451; G06F 40/205; G06F 40/30

(57) ABSTRACT

According to an aspect, a method includes receiving, via an interface, a natural language query about a request for a user device to perform a computer task, generating a prompt including the natural language query and a list of functions, transmitting the prompt to a language model, and receiving a response from the language model, where the response includes machine-readable instructions executable by the user device to perform the computer task. The machine-readable instructions use at least one function from the list of functions. The method includes executing the machine-readable instructions to perform the computer task.

### CROSS-REFERENCE TO RELATED APPLICATION

This application claims priority to U.S. Provisional Patent Application No. 63/513,440, filed on Jul. 13, 2023, entitled “COMPUTER TASK GENERATION USING A LANGUAGE MODEL”, the disclosure of which is incorporated by reference herein in its entirety.

### BACKGROUND

Conventionally, a user may use interface controls to execute computer actions on a user device such as opening or closing a browser tab, opening a setting menu, navigating to a web page, launching an application, moving a tab from one window to another window, etc. In order to group work tabs in a new browser window, a user may launch a new browser window, visually identify each tab to determine which tab relates to the user's work, and then move the user's work tabs to the new browsing window. In some examples, the user device includes a tab search feature that allows users to search for a specific tab or page among their open tabs, making it easier to locate and switch to a particular tab without having to manually navigate through many tabs.

### SUMMARY

This disclosure relates to a task assistant that receives, via an interface, a natural language query about a request to have a user device to perform a computer task and generates a prompt to a language model to generate machine-readable instructions to achieve the computer task using a list of functions. The task assistant may receive the machine-readable instructions generated by the language model and execute the machine-readable instructions to perform the computer task. In response to successful execution of the computer task, the task assistant may store the computer task in a command database, which may be re-used by the user to re-perform the computer task. In some examples, the task assistant may display a user interface (UI) element on the interface, which, when selected, causes the computer task to be re-performed. The task assistant may enable the user to manage their computing session with fewer user interactions than conventional management techniques. In addition, the task assistant may assist users with limited dexterity to complete computer tasks. For example, a user may control a user device using the task assistant to complete a multi-step computer task without manually manipulating input devices. In addition, the task assistant discussed herein may enable the generation of machine-readable instructions for computer tasks based on natural language queries and the execution of the computer tasks in a manner that is secure, reliable, and/or efficient, which may minimize or reduce the amount of computing resources (e.g., central processing unit (CPU) power, memory) for implementing new user commands on a computer device.

In some aspects, the techniques described herein relate to a computer-implemented method including: receiving, via an interface, a natural language query about a request for a user device to perform a computer task; generating, by an operating system of the user device, a prompt including the natural language query and a list of functions; transmitting, by the operating system, the prompt to a language model; receiving, by the operating system, a response from the language model, the response including machine-readable instructions executable by the user device to perform the computer task, the machine-readable instructions using at least one function from the list of functions; and executing, by the operating system, the machine-readable instructions to perform the computer task.

In some aspects, the techniques described herein relate to a non-transitory computer-readable medium storing instructions that cause at least one processor to execute operations, the operations including: receiving, via an interface, a natural language query about a request for a user device to perform a computer task; generating, by an operating system of the user device, a first prompt including the natural language query and a list of functions; transmitting, by the operating system, the first prompt to a language model; receiving, by the operating system, a response from the language model, the response including machine-readable instructions executable by the user device to perform the computer task, the machine-readable instructions using a first function and a second function from the list of functions; and executing, by the operating system, the machine-readable instructions to perform the computer task, including: executing, in a first step, a first source code portion causing execution of the first function by the operating system to obtain an execution result; and executing, in a second step, a second source code portion causing transmission of a second prompt that requests the language model to execute the second function on the execution result from the first step.

In some aspects, the techniques described herein relate to an apparatus including: at least one processor; and a non-transitory computer-readable medium storing executable instructions that when executed by the at least one processor cause the at least one processor to: receive, via an interface, a natural language query about a request for a user device to perform a computer task; generate, by an operating system of the user device, a prompt including the natural language query and a list of functions; transmit, by the operating system, the prompt to a language model; receive, by the operating system, a response from the language model, the response including machine-readable instructions executable by the user device to perform the computer task, the machine-readable instructions using at least one function from the list of functions; and execute, by the operating system, the machine-readable instructions to perform the computer task.

The details of one or more implementations are set forth in the accompanying drawings and the description below. Other features will be apparent from the description and drawings, and from the claims.

### BRIEF DESCRIPTION OF THE DRAWINGS

FIG. 1A illustrates a system including a task assistant for receiving a natural language query about a request for a user device to perform a computer request and communicating with a language model to cause the language model to create source code to implement the computer task according to an aspect.

FIG. 1B illustrates an example of the task assistant according to an aspect.

FIG. 1C illustrates an example of a command executor of the task assistant according to an aspect.

FIG. 1D illustrates an example of session state information according to an aspect.

FIG. 1E illustrates an example of an interface for receiving a natural language query about a request for a user device to perform a computer task according to an aspect.

FIG. 1F illustrates an example of using multiple language models to generate source code for implementing a computer task according to an aspect.

FIG. 1G illustrates an example of a language model according to an aspect.

FIG. 2 illustrates a system that distributes a language model on a user device and one or more server computers according to an aspect.

FIG. 3 illustrates an example interface for receiving a natural language query about a request for a user device to perform a computer request according to an aspect.

FIG. 4 illustrates an example interface for receiving a natural language query about a request for a user device to perform a computer request according to another aspect.

FIG. 5 illustrates an example interface for receiving a natural language query about a request for a user device to perform a computer request according to another aspect.

FIG. 6 illustrates an example interface for receiving a natural language query about a request for a user device to perform a computer request according to another aspect.

FIG. 7 illustrates an example interface for receiving a natural language query about a request for a user device to perform a computer request according to another aspect.

FIG. 8 illustrates an example interface for receiving a natural language query about a request for a user device to perform a computer request according to another aspect.

FIG. 9 illustrates a system for generating a computer task based on a natural language query according to an aspect.

FIG. 10 illustrates a system for generating a computer task based on a natural language query according to another aspect.

FIG. 11 is a flowchart depicting example operations of a system for implementing a computer task based on a natural language query according to an aspect.

FIG. 12A illustrates a system for generating a computer task based on a natural language query according to another aspect.

FIG. 12B illustrates examples of device data that is used in a prompt for generating a computer task according to an aspect.

FIG. 12C illustrates an example of generating modified structured data according to an aspect.

FIG. 12D illustrates an example of executing multi-step operations for performing a computer task according to an aspect.

FIGS. 13A to 13E illustrate an interface for receiving a natural language query to perform a computer task according to an aspect.

### DETAILED DESCRIPTION

This disclosure relates to a system that implements a technology solution that programmatically generates machine-readable instructions using a language model to execute new user commands by an operating system or a browser application that provides one or more technical benefits of reducing the complexity and the amount of computing resources of generating new user commands.

The system includes a task assistant that receives a natural language query about a request for a user device to perform a computer task and generates a request to a language model to generate machine-readable instructions (e.g., source code, JavaScript Object Notation (JSON, etc.) data) to achieve the computer task using a list of functions. The task assistant may receive the machine-readable instructions (e.g., source code, JSON data, etc.) from the language model and execute the machine-readable instructions (e.g., source code, JSON data, etc.) to perform the computer task. In some examples, the task assistant is a program executable by an operating system of the user device. The task assistant may initiate the generation of machine-readable instructions (e.g., source code, JSON data) to implement a wide range of computer tasks based on natural language requests (queries) to manage a computing session with less user interaction than conventional management techniques.

In some examples, the task assistant discussed herein provides a technical solution that enables the operating system to implement new user-customized computer tasks without requiring a code update to implement the new-customized computer tasks. For example, to enable a user to select a single command (or operate a single control) that programmatically groups work tabs in a new browser window, a code developer may create and test machine-readable instructions, and include the machine-readable instructions in an installation update to the operating system, and the installation update is installed on the user devices, which may require a relatively large amount of computer resources (e.g., central processing unit (CPU) power, memory) since the installation update would be applied to the devices (e.g., all devices) running the operating system.

However, the system discussed herein provides a technical solution that enables the user to implement a wide range of computer tasks (not previously included on the user device) with one or more technical benefits of avoiding costly installation updates, thereby minimizing or reducing the amount of computing resources for implementing new computer tasks on user devices. A further technical advantage of the technology described herein is that a user is enabled to create instructions for performing a computer task using a natural language interface and without requiring any programming skill. This can simplify the interaction of the user with the computer and enables the user to avoid complex or repetitive interaction with the computer by using and automating the interaction via a task assistant for creating a computer task implemented through instructions generated by a language model in response to a natural language query provided by the user.

The task assistant may assist the user in performing computer tasks during a computing session. The task assistant may display an interface for receiving a natural language query about a request for a user device to perform a computer task (e.g., “move all my tabs about home renovation to a new window”, “mute any tabs that are making noise”, “summarize my open tabs”, “open a tab that is different but similar to the tabs already open”, “close my music tab”, “find my tabs relating to work”, etc.). The computer task may be a user command whose machine-readable instructions are not included on the user device. In some examples, the computer task is a multi-step command that involves multiple steps. In response to submission of the natural language query, the task assistant may generate a prompt with the natural language query and a list of functions that may be used to perform the computer task. In some examples, the list of functions includes operations executable by the operating system. In some examples, the list of functions includes operations executable by the language model itself (e.g., semantic filter function, describe functions, and/or other types of functions). Execution of a function may include retrieving (or transmitting) data from (to) an application or performing a certain action.

In some examples, the functions include application programming interface (API) functions calls to interact with (e.g., retrieve from, transmit data to, or perform a specific action on) an application (e.g., a browser application, another application, or the operating system itself). Documentation about such API functions, their use, and example programs calling the API functions are typically publicly available and can be part of text data that the language model has been trained on. The language model used herein is, for example, a conventional large language model (e.g., based on a transformer architecture), adapted to generate text in response to a text prompt provided as input. Such large language models are commonly known as LLMs. Such LLMs are trained on a large corpus of publicly available text, e.g., content from public databases and websites. In some cases, the LLM can be part of the operating system, so that function calls to the operating system can be implemented using the LLM.

In response to the prompt, the language model generates machine-readable instructions to perform the computer task using one or more functions from the list of functions. For example, the language model determines which function(s) to use from the list of functions to accomplish the computer task and generates machine-readable instructions that use those function(s). In some examples, the machine-readable instructions include source code (e.g., JavaScript code). In some examples, the machine-readable instructions include JSON data. The task assistant receives a response from the language model, where the response includes the machine-readable instructions generated by the language model. The task assistant executes the machine-readable instructions to perform the computer task.

In some examples, in response to successful execution of the computer task, the task assistant may store the computer task (e.g., the machine-readable instructions of the computer task) in a command database that stores other computer tasks created by the user. In some examples, the task assistant displays a UI element in the interface, which, when selected, causes the task assistant to re-perform the computer task. For example, if the computer task is “group work tabs in a new window”, the interface displays a selectable UI element relating to “group work tabs in a new window”, which, when selected by the user, causes the open tabs relating to the user's work to be moved into a new browser window. In some examples, the selection of the UI element (e.g., a single UI element) may cause the user device to programmatically perform a multi-step computer task. The user may use the interface to create additional computer tasks, re-perform existing computer tasks, and/or delete existing computer tasks.

The task assistant may include an interpreter configured to validate the machine-readable instructions by semantically analyzing the machine-readable instructions received from the language model according to a defined set of rules. If the interpreter detects a validation error, the task assistant may transmit a prompt requesting re-generation of the machine-readable instructions, where the prompt may include information that indicates that the previous machine-readable instructions were not validated, and, in some examples, a description on why the source code was not validated. In response to the prompt, the language model may regenerate the machine-readable instructions and return the regenerated machine-readable instructions in a new response. Validation may, for example, detect that the text received from the language model is not in conformance with a syntax of instructions expected by the interpreter executing the instructions. Validation may detect that the text is in conformance with a syntax expected by the interpreter, however the function calls are not valid API calls.

In some examples, the interpreter includes a parser configured to parse the machine-readable instructions into executable instructions. In other words, the parser may generate executable instructions from the machine-readable instructions received from the language model. In some examples, the executable instructions include a sequence of stack operations executable by the operating system. In some examples, the parser is a JavaScript parser. For example, the parser may convert one or more JavaScript expressions to executable instructions such as a sequence of stack operations. In some examples, the machine-readable instructions included in the response from the language model includes the executable instructions. For example, the task assistant may request that the language model parse the machine-readable instructions into executable instructions and return the executable instructions in a response. For example, in response to a natural language query about a request to perform a computer task, the task assistant may transmit a prompt requesting that the language model generate JavaScript expression(s) from the natural language query and the list of functions and then parse the JavaScript expression(s) into executable instructions (e.g., a sequence of stack operations). In other words, the language model may parse the machine-readable instructions before returning the machine-readable instructions to the task assistant.

The task assistant may execute the machine-readable instructions to perform the computer task in a step or a sequence of steps (also referred to as operations or actions, and, in some examples, functions). The computer task may involve more computations than a simple command for which a command already exists on the user device. In some examples, the computer task includes a sequence of steps that accomplish a particular action (or actions) that is not implemented (yet) on the user device (e.g., the user device does not store machine-readable instructions (yet) to perform the computer task). For example, the machine-readable instructions may include a first code portion that uses a first function from the list of functions in a first step. The machine-readable instructions may include a second code portion that uses a second function from the list of functions in a second step. In some examples, the number of steps is determined based on the number of functions that are used to accomplish the computer task. In some examples, the task assistant may perform the computer task in a one-shot approach (e.g., a single step). For example, the task assistant may receive and execute machine-readable instructions, including call back handling (e.g., loops and asynchronous callbacks), that performs the computer task using a plurality of functions in a single step.

In some examples, if performance of the first step (e.g., caused by execution of the first code portion) results in the detection of an error (e.g., an error message), the task assistant transmits a prompt requesting the language model to generate replacement code for the first step and re-performs the first step using the replacement code. For example, during execution of the first step, the task assistant may detect an error message. The error message may indicate that the first step has failed, and, in some examples, may include information about the error. The task assistant may generate a prompt with a request to re-generate code for the first code portion. The prompt may also include information from the error message. In response to the prompt, the language model may generate replacement code for the first step and return the replacement code to the task assistant.

In some examples, in the first step, the task assistant executes the first code portion, which causes the operating system to execute the first function (e.g., open tabs), resulting in a first execution result. In some examples, the first execution result is stored (e.g., stored as a variable) at the operating system. In some examples, the first execution result is transferred to another function (e.g., a second function). In some examples, the first function may include obtaining session state information about a user's computer session (e.g., a user's browsing session). The session state information may identify one or more session items (e.g., application windows such as browser tabs and browser windows) used during the computing session. In some examples, the first execution result includes a list of session items (e.g., list of open tabs) with information (e.g., session state information) about each session item on the list. In some examples, execution of the first code portion causes the task assistant 110 to invoke an API function call to retrieve a list of open tabs from the browser application.

In some examples, in a second step, the task assistant executes the second code portion, which causes the operating system to execute the second function, resulting in a second execution result. In some examples, the second execution result is stored (e.g., stored as a variable) at the operating system. In some examples, the second execution result is transferred to another function (e.g., a third function). In some examples, during execution of the machine-readable instructions, the task assistant may transmit a prompt requesting the language model to execute a function in one or more of the steps. In other words, one or more of the functions that are used to perform the computer task may be executed by the language model (as opposed to the operating system). For example, in the second step, the task assistant executes the second code portion, which causes the task assistant to generate and transmit a prompt requesting the language model to execute the second function using the first execution result. In other words, the second code portion, which is based on instructions generated by the language model, includes a function call from the API of the language model itself. For example, execution of the second code portion causes the task assistant to request the language model to execute the second function on input data (e.g., the first execution result) and return a second execution result (e.g., the output of the second function) to the task assistant. In some examples, the prompt includes a request to execute the second function on the first execution result from the first step (e.g., the list of session items). The task assistant receives a response from the language model, where the response includes a second execution result, resulting from execution of the second function. The second execution result may be used in a subsequent step. In some examples, the first execution result is stored (e.g., stored as a variable) at the operating system. In some examples, the first execution result is transferred to another function.

In some examples, the second function includes a semantic filter function. Execution of the semantic filter function by the language model causes the language model to filter the list of session items to semantically related items that are related to one or more terms included in the natural language description. The second execution result may include the semantically related items. For example, with respect to a query “move all my tabs about home renovation to a new window”, a step of the computer task may involve execution of a semantic filter function configured to determine which browser tabs are semantically related to home renovation. In some examples, the language model may be a computer device better suited to intelligently determine which browser tabs are semantically related to one or more terms. Execution of the second code portion may cause the task assistant to transmit a prompt requesting the language model to execute the semantic filter function on the list of session items obtained from the first step in view of the term “home renovation.” Execution of the semantic filter function by the language model causes the language model to determine which of the open tabs are semantically related to the term “home renovation.” The language model generates and transmits a response to the task assistant, where the response includes the semantically related items. The task assistant uses the semantically related items from the model's response in one or more of the subsequent steps (e.g., create a new browser window, display the tabs semantically related to home renovation in the new browser window, etc.).

In some examples, the second function includes a describe function configured to generate a summary description about one or more session items. Execution of the describe function by the language model causes the language model to generate a summary description for each session item on the list of session items. The second execution result may include the summary descriptions. With respect to a query “summarize my open tabs”, a step of the computer task may include execution of a describe function configured to generate a summary description about each session item on the list of session items. Execution of the second code portion may cause the task assistant to transmit a prompt requesting the language model to execute the describe function on the list of session items from the first step. In response to the prompt, the language model generates a summary description for each of the list of session items from the first step. The language model may transmit a response to the task assistant, where the response includes the summary descriptions. The task assistant uses the semantically related items from the model's response in one or more of the subsequent steps (e.g., display the summary descriptions in the interface, etc. In some examples, one or more of the functions (e.g., the semantic filter function, the describe function, or another function) are not executed by a language model (e.g., an LLM) that is used to generate the machine-readable instructions, but may be executed by the operating system or another machine-learning model (e.g., another LLM model) that is fine-tuned or specialized to execute a particular function. These and other features are further described with reference to the figures.

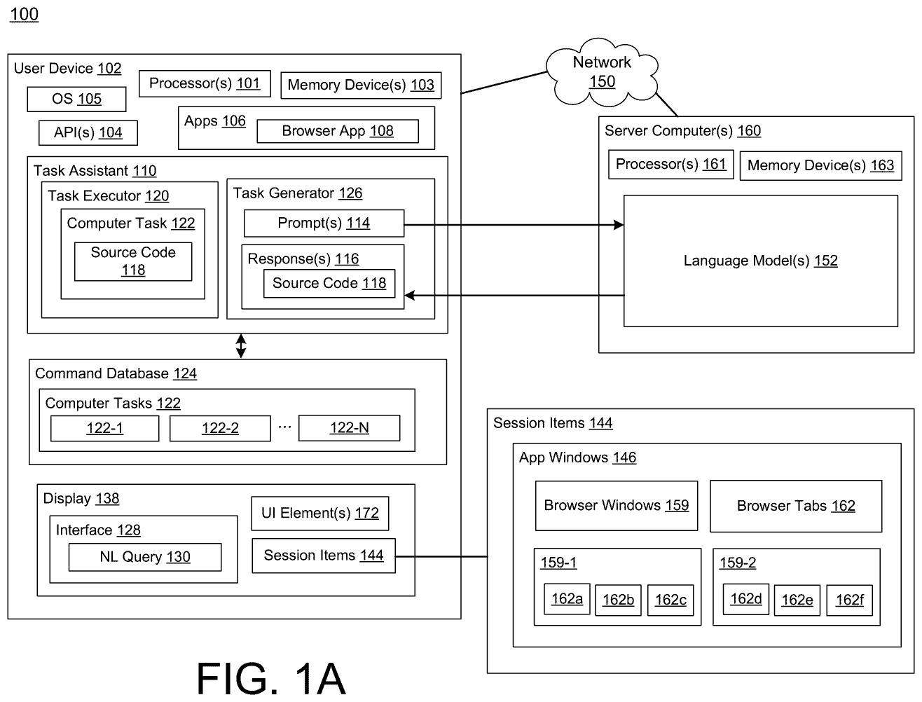

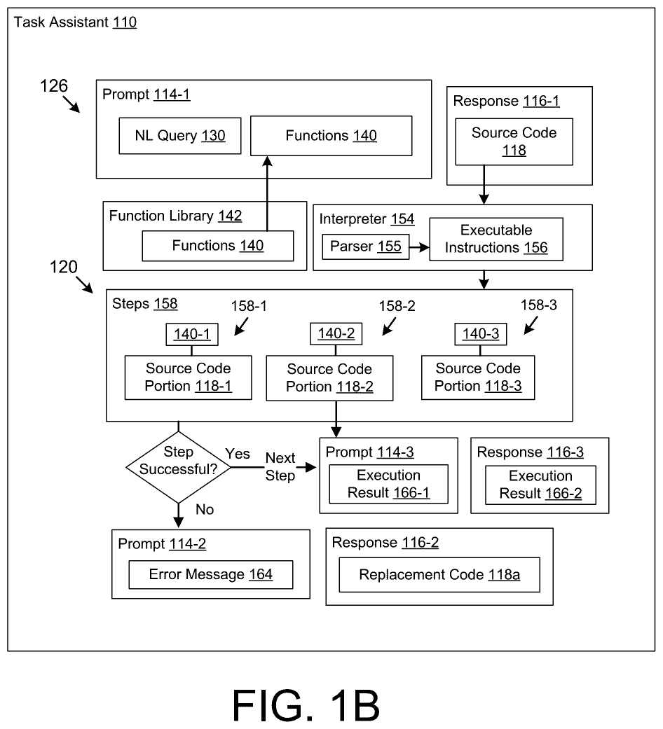

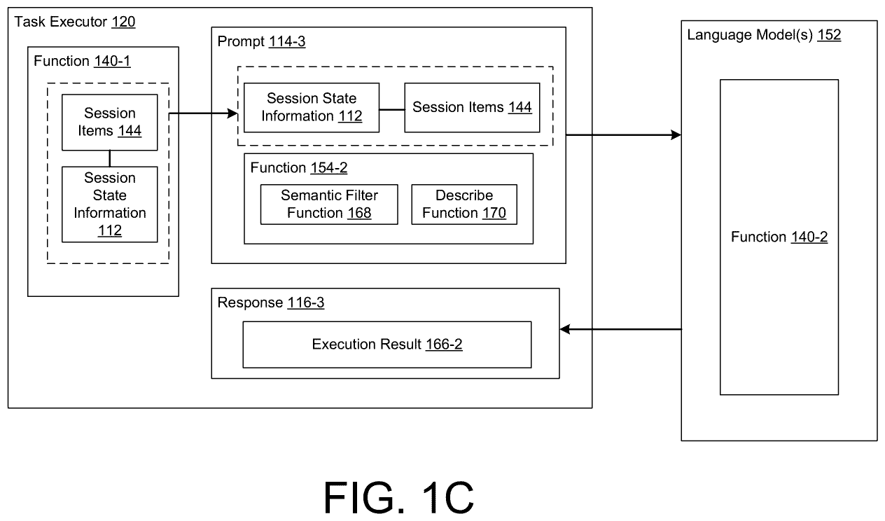

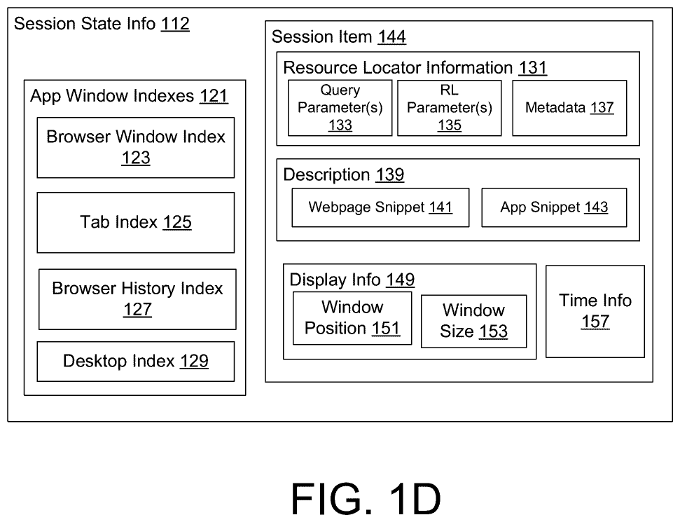

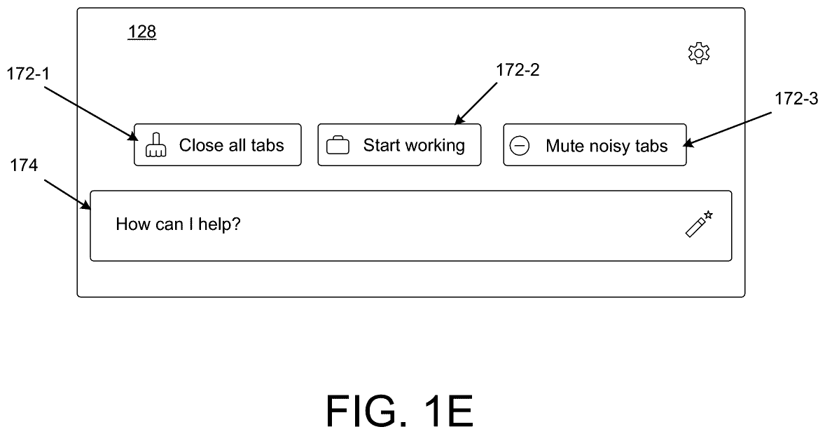

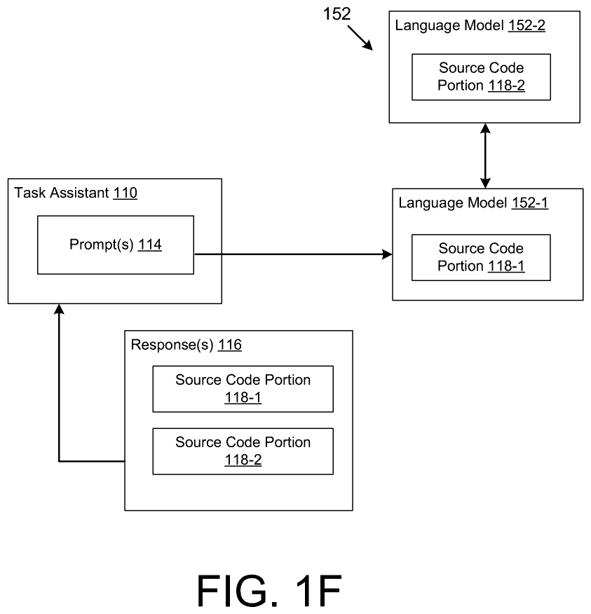

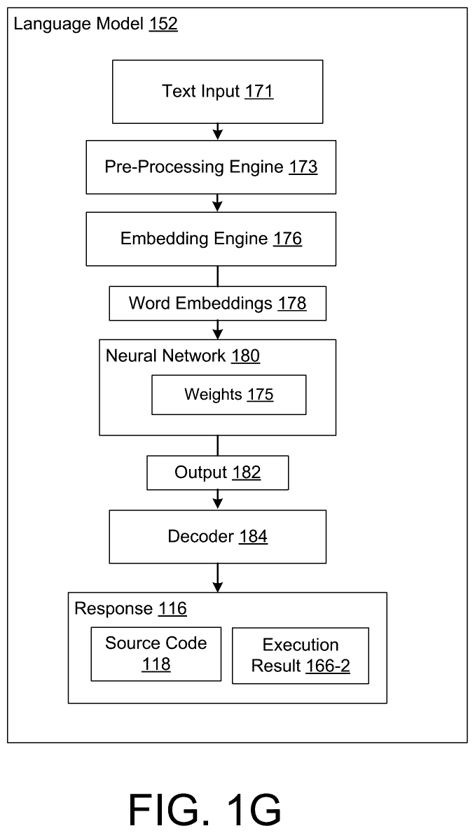

FIGS. 1A through 1G illustrate a system 100 that enables a user to create and perform a computer task 122 on a user device 102 based on a natural language query 130. In some examples, the system 100 defines a window management feature that can be used to perform computer tasks 122 with respect to session items 144 during a computer session based on natural language queries 130. The user device 102 includes a task assistant 110 that receives a natural language query 130 about a request to perform a computer task 122 and causes a language model 152 to generate source code 118 to perform the computer task 122 on the user device 102 in a manner that is secure, reliable, and/or efficient, which may minimize or reduce the amount of computing resources (e.g., central processing unit (CPU) power, memory) that are typically used for implementing new commands on an operating system 105 of a user device 102. While FIG. 1A shows the one or more language models 152 as part of a server computer 160, a language model 152 can also be implemented as part of the operating system 105 on the user device 102. In some examples, the operating system 105 may forward calls to functions that are implemented with one or more language model 152 to a server computer 160 executing the one or more language models 152.

For example, the system 100 discussed herein may enable the operating system 105 to implement new user-customized computer tasks (e.g., computer tasks 122) without requiring a code update to implement new operating system commands. For example, to enable a user to select a single command (e.g., user interface (UI) element 172) that programmatically implements a new computer task 122 (e.g., groups work tabs in a new browser window), a code developer may create and test source code, and include the source code in an installation update to the operating system 105, and the installation update is installed on the user devices, which may require a relatively large amount of computer resources (e.g., central processing unit (CPU) power, memory) since the installation update would be applied to the devices (e.g., all devices) running the operating system 105. However, the system 100 discussed herein may enable the user to implement a wide range of computer tasks 122 (not previously included on the user device 102) that may avoid costly installation updates, thereby minimizing or reducing the amount of computing resources for implementing new computer tasks 122 on the user devices 102. The system 100 discussed herein may initiate the generation of source code 118 to implement a wide range of computer tasks 122 based on natural language queries 130 to manage their computing session with less user interaction than conventional management techniques. A further technical advantage of the systems discussed herein is that a user is enabled to create instructions for performing a computer task 122 using a natural language interface (e.g., the interface 128) and without requiring any programming skill. This can simplify the interaction of the user with the user device 102 and enables the user to avoid complex or repetitive interaction with the user device 102 by using and automating the interaction via the task assistant 110.

The user device 102 may be any type of computing device that includes one or more processors 101, one or more memory devices 103, a display 138, and an operating system 105 configured to execute (or assist with executing) one or more applications 106, including a browser application 108. In some examples, the user device 102 is a laptop computer. In some examples, the user device 102 is a desktop computer. In some examples, the user device 102 is a tablet computer. In some examples, the user device 102 is a smartphone. In some examples, the user device 102 is a wearable device. In some examples, the display 138 is the display of the user device 102. In some examples, the display 138 may also include one or more external monitors that are connected to the user device 102.

The operating system 105 is a system software that manages computer hardware, software resources, and provides common services for the applications 106. In some examples, the operating system 105 is an operating system designed for a larger display 138 such as a laptop or desktop (e.g., sometimes referred to as a desktop operating system). In some examples, the operating system 105 is an operating system for a smaller display 138 such as a tablet or a smartphone (e.g., sometimes referred to as a mobile operating system). In some examples, the operating system 105 includes the task assistant 110. In some examples, the operations described with reference to the task assistant 110 (or any of the task assistant's subcomponents) may be operations performed by the operating system 105.

The task assistant 110 may receive a natural language query 130 via an interface 128 and communicate with the language model 152 via one or more application programming interface(s) 104 to cause the language model 152 to generate source code 118 for performing a computer task 122 involving one or more session items 144. In some examples, the source code 118 includes (is) machine-readable instructions. In some examples, the source code 118 includes (is) machine-executable instructions. A session item 144 may be any type of item that can be controlled by a user during a computer session. The session item(s) 144 may include application windows 146. An application window 146 may be an interface that is displayed on a display 138 of the user device 102. The application windows 146 may include browser windows 159 and browser tabs 162 rendered by a browser application 108. The application windows 146 may include application windows rendered by other applications 106 (e.g., non-browser applications). In some examples, the application windows 146 includes application windows associated with the operating system 105.

In some examples, the user may open a browser window 159-1 with a browser tab 162a, a browser tab 162b, and a browser tab 162c and a browser window 159-2 with a browser tab 162d, and a browser tab 162f on the display 138. The browser tabs 162a through 162f may include various applications and/or web documents (e.g., webpages, images, videos, etc.). The browser tab 162a may include a news webpage, the browser tab 162b may execute a gaming web application, the browser tab 162c may display an online word document, the browser tab 162d may display a customer relationship management (CRM) webpage, the browser tab 162e may display a search results page, and the browser tab 162f may display a music streaming webpage.

In response to a natural language query 130 (e.g., “where is my music tab”) submitted via the interface 128, the task assistant 110 may obtain source code 118 from the language model 152 and execute the source code 118 to identify the browser tab 162f as a browser tab 162 relating to music. In some examples, the task assistant 110 may provide a textual response about the location of the music tab (e.g., “it's the 3^{rd} browser tab in the 2^{nd} browser window”). In some examples, execution of the source code 118 may visually identify the browser tab 162f. In some examples, execution of the source code 118 may add a visual element in order to highlight the browser tab 162f. In some examples, execution of the source code 118 may cause the browser tab 162f to be rendered in a foreground of the display 138 to visually highlight the browser tab 162f.

The system 100 may enable the creation of a wide variety of computer tasks 122. For example, in response to a natural language query 130 (e.g., “close my news tab”), the task assistant 110 may obtain source code 118 from the language model 152 and execute the source code 118 that closes (e.g., terminate, remove) the browser tab 162a. In response to a natural language query 130, (e.g., “group my work tabs”), the task assistant 110 may receive source code 118 from the language model 152 and execute source code 118 to group the browser tab 162c and the browser tab 162d together (e.g., create a new browser window 159 with the browser tab 162c and the browser tab 162d). Other computer tasks 122 may include opening a new tab with a certain webpage, navigating a particular open browser tab 162 to a different webpage, de-duplicating browser tabs 162 with the same content, bookmarking a webpage displayed in a certain browser tab 162, etc.

In some examples, the session items 144 may include other types of items that are enabled, set, or created during a computer session such as settings (e.g., operating system settings, browser settings), display states (or modes) (e.g., split screen, picture-in-picture, and/or full-screen mode), and/or virtual desktops. A split screen display state, when enabled, may divide the display 138 into two independent display screen portions, and the user may place application windows 146. A natural language query 130 about a request to perform a computer task 122 involving a split screen display state (or a virtual desktop) may include a textual description that includes “enable the split screen feature (or create two virtual desktops) and place my work windows in one display screen portion (or one virtual desktop) and my personal windows in the other display screen portion (or the other virtual desktop).” A picture-in-picture display state may render a media window (or media player) in the foreground of the display 138 while the user can interact with other application windows 146. A natural language query 130 about a request to perform a computer task 122 involving a picture-in-picture display state may include a textual description that includes “create a picture-in-picture display for the video playing in my streaming application.” A natural language query 130 about a request to perform a computer task 122 involving a setting may include a textual description that includes “bookmark the webpage in my news tabs”, “tell me the last three webpages I visited”, “place the user device into a power saving mode”.

The task assistant 110 may display an interface 128 for receiving a natural language query 130 about a request to perform a computer task 122. Some examples of a natural language query 130 include move all my tabs about home renovation to a new window, mute any tabs that are making noise, summarize my open tabs, open a tab that is different but similar to the tabs already open, close my music tab, or find my tabs relating to work. However, the system 100 discussed herein provides a technical solution to support a wide range of natural language queries 130 for implementing computer tasks 122.

In some examples, the computer task 122 relates to a multi-step operation involving a browser application 108 (e.g., opening, closing, moving, rendering, organizing, grouping, and/or navigating within browser windows 159 and browser tabs 162, obtaining information related to a browser session, selection or enabling/disabling of browser controls and settings). In some examples, the computer task 122 may relate to one or more actions involving other applications 106 (e.g., non-browser applications) such as launching other applications 106 and/or controlling one or more aspects within the other applications 106. In some examples, the computer task 122 may relate to one or more actions involving the operating system 105 to manage and control their system resources, access applications 106, navigate user interfaces, and customize the computing experience. Generally, the computer task 122 may relate to window management (e.g., open, close, minimize, maximize, resize windows, etc.), application management (e.g., launch, manage, and/or install applications 106 on the user device 102), file management (e.g., create, organize, and/or manage files and directories including create new files and folders, rename or delete them, move or copy files between directories, and/or search for files), task management (e.g., view and switch between running applications or process, switch focus between different tasks, terminate or force quit unresponsive programs, and monitor system resource utilization through task managers), manage settings and configurations (e.g., adjust display settings, network connections, manage peripheral devices, adjust power options, accessibility features, and/or user interface customization (e.g., wallpaper, themes, colors, and icon sizes).

As shown in FIG. 1E, the interface 128 includes an input field 174 for receiving the natural language query 130. In some examples, a user may enter text into the input field 174 to define the natural language query 130. In some examples, the interface 128 may be a user interface configured to receive text via a voice command and may display the text of the voice command in the input field 174. In some examples, the interface 128 includes a UI object. In some examples, the interface 128 may be fixed to a location on the display 138 and/or may move to other portions of the display 138. The task assistant 110 may render the interface 128. In some examples, the task assistant 110 may render the interface 128 in response to a selection of a UI element, such as launching the task assistant 110. In some examples, the interface 128 is a user interface of the operating system 105.

In response to submission of a natural language query 130, the interface 128 may display a textual response that indicates that the computer task 122 is being generated. In some examples, after the computer task 122 is generated and executed, the interface 128 may display a textual response indicating that the computer task 122 is complete. In some examples, the interface 128 may display the status of generating and/or performing each step 158 of the computer task 122. In some examples, the interface 128 may display, for each step 158, the source code portion, and indicate whether it is running or completed so that the user can view the progress of the computer task generation. In some examples, after the computer task 122 is generated and executed, the computer task 122 may be stored in a command database 124, and the interface 128 may display a UI element 172 corresponding to the computer task 122. The UI clement 172, when selected, is configured to cause the task assistant 110 to re-execute the computer task 122. Since the computer task 122 has already been generated, re-execution of the computer task 122 may be processed relatively quickly. For example, as shown in FIG. 1E, the interface 128 includes a UI element 172-1 corresponding to the computer task 122-1, a UI clement 172-2 corresponding to the computer task 122-2, and a UI element 172-3 corresponding to another computer task 122. The UI elements 172 may be selectable, which causes the underlying computer task 122 to be re-performed.

In some examples, the interface 128 is an interface that enables the user to submit a natural language query 130 about a computer task 122, and, in some examples, includes one or more UI controls (e.g., an edit) that enables the user to edit the computer task 122. In some examples, after a computer task 122 has been saved (e.g., stored in the command database 124), the user may edit the saved computer task 122. For example, in response to a selection of an edit UI control, the user may edit/change the computer task 122 with natural language requests. If the user requested “close all my tabs about tools”, they could follow up with “make it so that it also closes tabs about home renovation.” In some examples, the task assistant may automatically initiate modification of a computer task 122 (or may initiate modification of a computer task 122 in response to a request from the user via the interface 128). For example, if the user makes a specific request (e.g., “close tabs about home renovation”), the task assistant 110 may prompt the language model 152 to create a generalized computer task 122. Generalizing a specific computer task 122 may include replacing specific topics with placeholders and/or providing one or more prompts back to the user via the interface 128. For example, with respect to the task “close tabs about home renovation”, a request to modify a computer task 122 may include “ask me for a topic, then close the tabs related to that topic.” A user could make the same change by asking for a refinement such as “instead of home improvement ask me for the topic.”

In some examples, the interface 128 is a chat interface that identifies a history of textual data submitted by the user and textual responses provided by the task assistant 110. For example, a user may enter a natural language query 130 in the interface 128 (e.g., “identify my gaming tab”), and, in response to performance of the computer task 122, the task assistant 110 may display a textual response (e.g., “it's the second tab in the first window”) in the interface 128 and/or may cause the user device 102 to visually identify the gaming tab (e.g., placing the gaming tab in the foreground or highlighting the gaming tab). Then, the user may select a UI element 172 corresponding to another computer task 122 or enter a natural language query 130 in the interface 128 (e.g., “delete that tab”), and, in response to performance of the computer task 122, the task assistant 110 may delete the browser tab 162 and display a textual response (e.g., “ok, it's deleted”) in the interface 128. In some examples, the natural language queries 130, and, in some examples, the textual responses provided by the task assistant 110 during a computing session may be stored (e.g., temporarily stored) as contextual data, and the contextual data may be included in one or more of the prompts 114 transmitted to the language model 152. A prompt 114 is the input or text that is provided to a language model 152.

A computer task 122 may be a step or sequence of steps executable by a computer not yet implemented on the user device 102. For example, the operating system 105 and/or the browser application 108 may include individual commands (e.g., shortcut keys) or user controls that enable the user to perform some actions with respect to the session items 144 such as creating a new browser tab 162, closing an existing browser tab 162, and/or moving a browser tab 162 from one browser window 159 to another browser window 159. However, these preexisting commands or controls may be limited, which can cause the user to perform multiple actions to accomplish a particular computer task.

However, the task assistant 110 may allow the user to generate a customized command (e.g., the computer task 122) using a natural language query 130, which may enable the generation of a wide variety of computer tasks 122 that were previously not defined by the operating system 105. In some examples, the task assistant 110 may enable the user to create customized keys (e.g., shortcut keys) for user-defined functions that are executable by the operating system 105 and/or the language model 152 based on natural language queries 130.

The task assistant 110 includes a task generator 126 configured to communicate with the language model 152 to obtain source code 118 to perform a computer task 122 described in a natural language query 130. In response to submission of the natural language query 130 about a request to perform a computer task 122, as shown in FIG. 1B, the task generator 126 may generate one or more prompts 114-1 to create source code 118 that performs the computer task 122. A prompt 114-1 is a request to generate source code 118 using the natural language query 130 and a list of functions 140. For example, the task generator 126 is configured to generate a prompt 114-1 that includes the natural language query 130 that was received from the user via the interface 128 (e.g., typed into an input field 174 or received via a voice command).

The prompt 114-1 may include a list of functions 140 that may be used to perform the computer task 122. In other words, the prompt 114-1 may include a textual description that indicates to generate source code 118 using the natural language query 130 with a list of functions 140. In some examples, the functions 140 include predefined operations executable by the operating system 105 and/or the language model 152. In some examples, the list of functions 140 includes operations executable by the operating system 105. In some examples, the list of functions 140 includes operations executable by the language model 152 itself. Execution of a function 140 may include retrieving (or transmitting) data from (to) an application or performing a certain action. In some examples, the functions 140 include one or more operations that may be executed by another language model (e.g., language model 152-2 in FIG. IF). For example, a certain application (App1) (e.g., a website or native application) may have their own assistant (e.g., language model 152-2) that is specifically-tuned or trained to have a better understanding of the application's functionality. In response to a natural language query 130 (e.g., “subscribe to X on App1”), the task assistant 110 may cause the language model 152 to generate source code 118 that causes the operating system 105 to open a new tab with App1.com and delegates a function (e.g., the subscribe-to-x request) to App1's assistant (e.g., language model 152-2).

In some examples, the functions 140 include application programming interface (API) functions calls to interact with (e.g., retrieve from, transmit data to, or perform a specific action on) an application 106 (e.g., a browser application 108, another application 106, or the operating system 105 itself). In some examples, the functions 140 include operations that enable the operating system 105 (e.g., the task assistant 110) to interact with and/or control aspects of an application 106 (e.g., a browser application 108, another application 106, or the operating system 105 itself). Some examples of functions 140 includes API function calls for obtaining a list of browser tabs 162, obtaining a list of browser windows 159, obtaining a list of browser tabs 162 in browser windows 159, obtaining a list of browser windows 159 that include browser tabs 162, obtaining a subset of tabs that semantically match a search criteria, closing one or more browser tabs 162, closing one or more browser windows 159, and/or opening a new browser tab 162 with a resource locator (e.g., URL), among others. In some examples, the task generator 126 may identify the functions 140 from a function library 142 and include the functions 140 in the prompt 114-1. Documentation about such API functions, their use, and example programs calling the API functions are typically publicly available and can be part of text data that the language model 152 has been trained on. The language model 152 used herein is, for example, a conventional large language model, e.g., based on a transformer architecture, adapted to generate text in response to a text prompt provided as input. Such large language models are commonly known as LLMs. Such LLMs are trained on a large corpus of publicly available text, e.g., content from public databases and websites. In some cases, the LLM can be part of the operating system 105, so that function calls to the operating system 105 can be implemented using the LLM.

The task generator 126 may transmit the prompt 114-1, over the network 150, to the language model 152. In response to the prompt 114-1, the language model 152 may generate source code 118 to perform the computer task 122. The source code 118 uses one or more of the functions 140 provided in the prompt 114-1. The task generator 126 may receive a response 116-1 from the language model 152, where the response 116-1 includes the source code 118.

The task generator 126 may include an interpreter 154 configured to validate the source code 118 by semantically analyzing the source code 118 received from the language model 152 according to a defined set of rules. If the interpreter 154 detects a validation error, the task generator 126 may transmit a prompt (e.g., another prompt 114-1) requesting re-generation of the source code 118, where the prompt 114-1 may include information that indicates that the previous source code 118 was not validated, and, in some examples, a description on why the source code 118 was not validated. In response to the prompt 114-1, the language model 152 may regenerate the source code 118 and return the regenerated source code 118 in a new response 116-1. In some examples, the interpreter 154 may detect that the text received from the language model 152 is not in conformance with a syntax of instructions expected by the interpreter 154 executing the source code 118. In some examples, the interpreter 154 may detect that the text is in conformance with a syntax expected by the interpreter 154, however the function calls are not valid API calls.

In some examples, the interpreter 154 includes a parser 155 configured to parse (e.g., convert) the source code 118 (e.g., machine-readable instructions) into executable instructions 156. In other words, the parser 155 may generate executable instructions 156 from the source code 118 received from the language model 152. The executable instructions 156 may be the source code 118 in a machine-executable format. In some examples, the executable instructions 156 include a sequence of stack operations executable by the operating system 105. In some examples, the executable instructions 156 includes an abstract syntax tree (AST). In some examples, the executable instructions 156 includes a parse tree. In some examples, the interpreter 154 may examine the source code 118 to identify its syntax, validate the source code 118 according to the defined set of rules associated with the syntax, and/or use the parser 155 to generate the executable instructions 156 that represents the source code 118 in a machine-executable format. In some examples, the parser 155 attempts to parse the source code 118, and, in response to a failure to parse the source code 118, the task generator 126 may transmit another prompt 114-1 requesting the language model 152 parse the source code 118. In some examples, the parser 155 is a JavaScript parser. For example, the parser 155 may convert one or more JavaScript expressions (e.g., machine-readable instructions) to executable instructions 156 such as a sequence of stack operations. In some examples, the interpreter 154 is configured to also operate as a compiler to compile the executable instructions 156.

In some examples, the source code 118 included in the response 116-1 from the language model 152 includes the executable instructions 156. For example, the task generator 126 may request that the language model 152 parse the source code 118 into executable instructions 156 and return the executable instructions 156 in a response 116-1. For example, in response to a natural language query 130 about a request to perform a computer task 122, the task generator 126 may transmit a prompt 114-1 requesting that the language model 152 generate JavaScript expression(s) from the natural language query 130 and the list of functions 140 and then parse (e.g., convert) the JavaScript expression(s) into executable instructions 156 (e.g., a sequence of stack operations). In other words, the language model 152 may parse the source code 118 before returning the source code 118 to the task generator 126. In some examples, the task generator 126 may transmit a prompt 114-1 requesting the language model 152 to generate a parser 155 (e.g., a JavaScript parser) for converting the source code 118 into the executable instructions 156. If the source code 118 included in the response 116-1 includes the executable instructions 156, the interpreter 154 may perform one or more other operations (e.g., besides parsing) such as validating the executable instructions 156 according to the defined set of rules associated with the syntax and/or compiling the executable instructions 156.

The task assistant 110 includes a task executor 120 configured to perform the computer task 122 by executing the source code 118 (e.g., the executable instructions 156). In some examples, in response to successful performance of the computer task 122, the task assistant 110 may store the computer task 122 in a command database 124 that stores other computer tasks 122 created by the user. For example, the command database 124 may store computer task 122-1 and computer task 122-2 through computer task 122-N. The integer N may be any value greater or equal to two. In some examples, the system 100 limits the number of computer tasks 122 that can be created by a particular user and stored in the command database 124 (e.g., users may be limited to five, ten, fifty, or hundred computer tasks 122).

In some examples, the task assistant 110 may cause a UI element 172 to be displayed in the interface 128, which, when selected, causes the task assistant 110 to re-perform the computer task 122. In some examples, the computer tasks 122 may be shortcut keys, which, when selected, causes the task executor 120 to re-perform the computer task 122. For example, if the computer task 122 is “mute noisy tabs”, the interface 128 may display a selectable UI clement 172 relating to “mute noisy tabs”, which, when selected by the user, causes the computer task 122 to be re-performed. The user may use the interface 128 to create additional computer tasks 122, re-perform existing computer tasks 122, and/or delete existing computer tasks 122 from the command database 124.

The task executor 120 may execute the source code 118 to perform the computer task 122 in a step 158 or a sequence of steps 158 (also referred to as operations or actions, and, in some examples, functions). The computer task 122 may involve more computations than a simple command for which a command already exists on the user device 102. In some examples, the number of steps 158 is determined based on the number of functions 140 that are used to accomplish the computer task 122. In some examples, a step 158 includes a single function 140, and, in some examples, may include other computer operations such as operation(s) on an input to the function 140 and/or operation(s) on the output of the function 140 (e.g., storing an execution result of the function 140 in a register or other operations relating to the function 140). In some examples, the computer task 122 includes a sequence of steps 158 that accomplish a particular action (or actions) that is not implemented (yet) on the user device 102 (e.g., the user device 102 does not store source code 118 (yet) to perform the computer task 122).

As shown in FIG. 1B, the source code 118 may include a source code portion 118-1 that uses a function 140-1 from the list of functions 140 in a step 158-1. The source code 118 may include a second source code portion 118-2 that uses a second function 140-2 from the list of functions 140 in a step 158-2. The source code 118 may include a source code portion 118-3 that uses a second function 140-3 from the list of functions 140 in a step 158-3. Although three steps 158 are illustrated in FIG. 1B, it is noted that the source code 118 may define any number of steps 158 including a single step 158, two steps 158, or any number of steps 158 greater than three.

In some examples, if performance of the step 158-1 (e.g., caused by execution of the source code portion 118-1) results in the detection of an error (e.g., an error message 164), the task executor 120 transmits a prompt 114-2 requesting the language model 152 to generate replacement code 118a for the step 158-1 and the task executor 120 re-performs the step 158-1 using the replacement code 118a. For example, during performance of the first step 158-1, the task executor 120 may detect an error message 164. The error message 164 may indicate that step 158 has failed, and, in some examples, may include information about the error. The task executor 120 may generate a prompt 114-2 with a request to re-generate source code for the source code portion 118-1. The prompt 114-2 may also include information from the error message 164. In response to the prompt 114-2, the language model 152 may generate replacement code 118a for the step 158-1 and return the replacement code 118a to task executor 120 in a response 116-2. The task executor 120 may replace the source code portion 118-1 with the replacement code 118a and re-execute the step 158-1 using the replacement code 118a. If another error message 164 is detected from re-execution of the step 158-1, the task executor 120 may re-prompt the language model 152 to generate a new version of the replacement code 118a, and the task executor 120 may re-execute the step 158-1 with the new version of the replacement code 118a. In response to a successful execution of the step 158-1, the task executor 120 may continue to the subsequent step (e.g., step 158-2). The task executor 120 may determine whether or not the subsequent step is successful, and, if not, may prompt the language model 152 for replacement code 118a in the same manner as explained with respect to step 158-1.

In some examples, during execution of the source code 118, the task executor 120 may transmit a prompt 114-3 requesting the language model 152 to execute a function 140 in one or more of the steps 158. In other words, one or more of the functions 140 that are used to perform the computer task 122 may be executed by the language model 152 (as opposed to the task executor 120, e.g., the operating system 105). In other words, execution of a source code portion 118-2 may cause the task executor 120 to invoke the language model 152 to execute a function 140 for performing the computer task 122.

In the step 158-1, the task executor 120 executes the source code portion 118-1, which causes the operating system 105 to execute the function 140-1 (e.g., get open tabs), resulting in an execution result 166-1. In some examples, as shown in FIG. 1C, the function 140-1 may include obtaining session state information 112 about one or more session items 144 (e.g., application windows 146 such as browser tabs 162 and browser windows 159) used during the computing session. In some examples, the execution result 166-1 includes a list of session items 144 (e.g., list of open tabs) with information (e.g., session state information 112) about each session item 144 on the list. In some examples, execution of the source code portion 118-1 causes the task executor 120 to invoke an API function call to retrieve a list of session items 144 (e.g., open tabs) from the browser application 108.

In the second step 158-2, the task executor 120 executes the source code portion 118-2, which causes the task executor 120 to generate and transmit a prompt 114-3 requesting the language model 152 to execute the function 140-2 using the execution result 166-1. For example, execution of the source code portion 118-2 causes the task executor 120 to request the language model 152 to execute the function 140-2 on input data (e.g., the execution result 116-1) and return an execution result 166-2 (e.g., the output of the function 140-2) to the task executor 120. In some examples, the prompt 114-3 includes a request to execute the function 140-2 on the execution result 166-1 from the step 158-1 (e.g., the list of session items 144). The task executor 120 receives a response 116-3 from the language model 152, where the response 116-3 includes the execution result 166-2, resulting from execution of the function 140-2. The execution result 166-2 may be used in a subsequent step, e.g., step 158-3.

The session state information 112 may include information about the user's computer activity such as which application windows 146 were opened (e.g., created, launched, enabled) and/or information about the underlying resource (e.g., webpage, application, and/or program). In some examples, the session state information 112 includes information about the user's settings and/or display states. A user may be provided with controls allowing the user to make an election as to both if and when the system 100 described herein may enable collection of user information (e.g., such as the session state information 112 (or a portion thereof)), and/or whether or not to enable the language model 152 to operate with respect to the user's computing session. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

The session items 144 may include application windows 146 that have been opened by the user. An application window 146 may be a graphical user interface that represents an application 106 executing on or associated with the operating system 105 of the user device 102. In other words, the session items 144 may be applications 106 that are launched by the user, which may encompass browser tabs 162 (and associated functionalities such as web application and extensions) and other types of applications such as native applications, programs, etc. In some examples, the session items 144 may include other items that are created or enabled by the user during a computing session such as display states or settings.

The application windows 146 may include browser windows 159 and browser tabs 162 rendered by a browser application 108. A browser application 108 is a web browser configured to access information on the Internet. The browser application 106 may launch one or more browser tabs 162 in the context of one or more browser windows 159 on a display 138 of the user device 102. A browser tab 162 may display content (e.g., web content) associated with a web document (e.g., webpage, PDF, images, videos, etc.) and/or an application 106 such as a web application, progressive web application (PWA), and/or extension. A web application may be an application program that is stored on a remote server (e.g., a web server) and delivered over the network 150 through the browser application 108 (e.g., a browser tab 162). In some examples, a progressive web application is similar to a web application but can also be stored (at least in part) on the user device 102 and used offline. An extension adds a feature or function to the browser application 108. In some examples, an extension may be HTML, CSS, and/or JavaScript based (for browser-based extensions).

In some examples, the application windows 146 may correspond to other applications, programs, and/or computer files (e.g., in addition to browser tabs 162). For example, the application window 146 may correspond to other native applications (e.g., non-browser applications) executing on the operating system 105 of the user device 102 and/or system programs included in the operating system 105 of the user device 102.

As shown in FIG. 1D, the session state information 112 may include one or more application window indexes 121 associated with the application windows 146. Generally, an application window index 121 may be an identifier (e.g., a window ID) assigned to an application window 146 displayed on the display 138. In some examples, the identifiers are assigned by a window manager. In some examples, an application window index 121 includes an index vector having one or more identifiers (e.g., unique identifiers that can identify the application windows 146). For example, if there are more than one application window 146 displayed on the display 138, the application window index 121 includes a plurality of identifiers (e.g., an index vector), where an identifier corresponds to a separate application window 146.

In some examples, the session state information 112 may include a single application window index 121 that identifies any application window 146 displayed on the display 138, and, in some examples, a relationship with another application window 146. For example, the application window index 121 may associate browser tab 162a, browser tab 162b, and browser tab 162c with browser window 159-1, and browser tab 162d, browser tab 162c, and browser tab 162f with browser window 159-2. However, the application window index 121 may identify relationships with other computer elements (e.g., desktops (also referred to as virtual desktops) and users (or user accounts)). For example, the application window index 121 may identify browser window 159-1 and browser window 159-2 with a particular desktop (e.g., if multiple desktops are created by the user) and/or with a particular user identifier (e.g., if multiple users are configured to use the user device 102).

In some examples, the application window indexes 121 may include multiple (smaller) application window indexes 121. For example, the application window indexes 121 may include a browser window index 123 that includes an identifier (e.g., a window ID) assigned to each browser window 159 displayed on the display 138. The application window indexes 121 may include a tab index 125 that includes an identifier (e.g., a tab ID) assigned to each browser tab 162 displayed within a respective browser window 159. In some examples, the application window indexes 121 include a browser history index 127 that identifies a web document or application rendered in a browser tab 162 (e.g., title, URL, metadata, etc.). In some examples, the application window indexes 121 include a desktop index 129 that includes an identifier (e.g., desktop ID) for each desktop created on the user device 102 and which application window 146 corresponds to which desktop. The identifiers (e.g., window IDs, tab IDs, desktop IDs, etc.) may be used to programmatically organize (e.g., move, switch, open, close, or other actions) the application windows 146.

The session state information 112 may include information about each session item 144 (e.g., each window ID, browser window ID, and/or tab ID). In some examples, the session state information 112 may include resource locator information 131 that identifies a location of (and, in some examples, other information associated with) a resource (e.g., web document, application) corresponding to an application window 146. The resource locator information 131 may include query parameter(s) 133, resource locator (RL) parameter(s) 135, and/or metadata 137. The RL parameters 135 may include an address (e.g., a web address), a domain name, path information, and other information that can identify a resource on a server computer or the user device 102. The query parameter(s) 133 may include additional information about the resource such as filtering or sorting options. The metadata 137 may include a wide variety of information such as the title of the resource, a description (e.g., description 139), keywords, an author, a language of the resource, a viewport of the resource (e.g., dimensions and scaling of a webpage).

In some examples, the session state information 112 may include a description 139 of the resource associated with the application window 146. In some examples, the description 139 is included as part of the metadata 137. In some examples, the description 139 is included in a head section of an HTML document. In some examples, the description 139 includes a webpage snippet 141 (e.g., a snippet description) that provides a brief summary or description of the webpage's content. In some examples, the description 139 includes an application snippet 143 (e.g., a snippet description) that provides a brief summary or description of the application corresponding to the application window 146. In some examples, the session state information 112 may include display information 149 about a location of an application window 146 on the display 138. The display information 149 may include a window position 151, a window size 153, and/or time information 157 about a time in which the application window 146 was rendered.

In some examples, as shown in FIG. 1C, the session state information 112 may include information (e.g., resource locator information 131, description 139, and/or display information 149) about a list of session items 144 (e.g., open browser tabs 162). The task executor 120 may transmit a prompt 114-3 to the language model 152 causing the language model 152 to execute the function 154-2 with the session state information 112. In some examples, the task assistant 110 may generate a prompt 114-3 with a request to execute the function 154-2 with the session state information 112 about the list of session items 144 obtained from execution of the function 140-1.

In some examples, as shown in FIG. 1C, the function 154-2 includes a semantic filter function 168. Execution of the semantic filter function 168 by the language model 152 causes the language model 152 to filter the list of session items 144 to semantically related items that are related to one or more terms included in the natural language query 130. The execution result 166-2 may include the semantically related items. For example, with respect to a query “move all my tabs about home renovation to a new window”, a step 158-2 of the computer task 122 may involve execution of a semantic filter function 168 configured to determine which browser tabs 162 are semantically related to home renovation. In some examples, the language model 152 may be a computer device better suited to intelligently determine which browser tabs 162 are semantically related to one or more terms. Execution of the source code portion 118-2 may cause the task executor 120 to transmit a prompt 114-3 requesting the language model 152 to execute the semantic filter function 168 on the list of session items 144 obtained from the step 158-1 in view of the term “home renovation.” Execution of the semantic filter function 168 by the language model 152 causes the language model 152 to determine which of the open browser tabs 162 are semantically related to the term “home renovation.” The language model 152 generates and transmits a response 116-3 to the task executor 120, where the response 116-3 includes the semantically related items. The task executor 120 uses the semantically related items from the model's response 116-3 in one or more of the subsequent steps (e.g., step 158-3).

In some examples, the function 140-2 includes a describe function 170 configured to generate a summary description about one or more session items 144. Execution of the describe function 170 by the language model 152 causes the language model 152 to generate a summary description for each session item 144 on the list of session items 144. The execution result 166-2 may include the summary descriptions. With respect to a query “summarize my open tabs”, a step 158-2 of the computer task 122 may include execution of a describe function 170 configured to generate a summary description about each session item 144 on the list of session items 144. Execution of the second source code portion 118-2 may cause the task executor 120 to transmit a prompt 114-3 requesting the language model 152 to execute the describe function 170 on the list of session items 144 from the step 158-1. In response to the prompt 114-3, the language model 152 generates a summary description for each of the list of session items 144 from the step 158-1. The language model 152 may transmit a response 116-3 to the task executor 120, where the response 116-3 includes the summary descriptions. The task executor 120 uses the semantically related items from the model's response 116-3 in one or more of the subsequent steps, e.g., step 158-3.

Referring to FIG. 1F, in some examples, the task assistant 110 may transmit one or more prompts 114 to one or more language model 152 that causes multiple language models 152 to generate source code 118 for the computer task 122. The language models 152 may be associated with different applications 106. For example, a language model 152-1 may be associated with the operating system 105 and/or the browser application 108, and a language model 152-2 may be associated with another application 106 (e.g., webpage, web application, or native application). In some examples, the language model 152-2 is trained to understand the structure of application 106, including any interfaces associated with the application 106.

The task assistant 110 may transmit a prompt 114 to the language model 152-1 that requests the language model 152-1 to generate source code 118 for the computer task 122 using the list of functions 140. The language model 152-1 may generate a source code portion 118-1 using a function 140-1 from the list of functions 140. The language model 152-1 may determine that a function 140-2 is associated with the application 106 (and therefore, the language model 152-2) and the language model 152-1 may transmit a prompt 114 requesting that the language model 152-2 generate a source code portion 118-2 that uses the function 140-2. The language model 152-2 may return a response 116 with the source code portion 118-2 to the language model 152-1, and the language model 152-1 may transmit a response 116 to the task assistant 110, where the response 116 includes the source code portion 118-1 and the source code portion 118-2.

The language model 152 may include any type of pre-trained large language model (LLM) configured to generate source code 118 in response to text input 171. As shown in FIG. 1G, the language model 152 includes weights 175. The weights 175 are numerical parameters that the language model 152 learns during the training process. The weights 175 are used to compute the output (e.g., the responses 116 including the response 116-1, the response 116-2, the response 116-3) of the language model 152. In some examples, the language model 152 includes a pre-trained language model configured to generate source code 118 in response to text input 171, but has been fine-tuned with additional training data to generate source code for the type of operating system 105 associated with the user device 102.

The language model 152 may receive text input 171. The text input 171 includes the prompt 114 (e.g., the prompt 114-1, the prompt 114-2, the prompt 114-3). The language model 152 includes a pre-processing engine 173 configured to pre-process the text input 171. Pre-processing may include converting the text input 171 to individual tokens (e.g., words, phrases, or characters). Pre-processing may include other operations such as removing stop words (e.g., “the”, “and”, “of”) or other terms or syntax that do not impart any meaning to the language model 152. The language model 152 includes an embedding engine 176 configured to generate word embeddings 178 from the pre-processed text input 171. The word embeddings 178 may be vector representations that assist the language model 152 to capture the semantic meaning of the input tokens and may assist the language model 152 to better understand the relationships between the input tokens.

The language model 152 includes neural network(s) 180 configured to receive the word embeddings 178 and generate an output 182. A neural network 180 includes multiple layers of interconnected neurons (e.g., nodes). The neural network 180 may include an input layer, one or more hidden layers, and an output later. The output 182 may include a sequence of output word probability distributions, where each output distribution represents the probability of the next word in the sequence given the input sequence so far. In some examples, the output 182 may be represented as a probability distribution over the vocabulary or a subset of the vocabulary. The neural network(s) 180 is configured to receive the word embeddings 178 and generate an output 182, and, in some examples, the query activity (e.g., previous natural language queries 130 and textual responses from the task assistant 110). The output 182 may represent a version of the textual response. The output 182 may include a sequence of output word probability distributions, where each output distribution represents the probability of the next word in the sequence given the input sequence so far. In some examples, the output 182 may be represented as a probability distribution over the vocabulary or a subset of the vocabulary. The decoder 184 is configured to receive the output 182 and generate the source code 118. In some examples, the decoder 184 may select the most likely instruction, sampling from a probability distribution, or using other techniques to generate coherent and valid source code 118. The language model 152 includes a decoder 184 configured to receive the output 182 and generate a response 116 with the source code 118 or the execution result 166-2.

The processor(s) 101 may be formed in a substrate configured to execute one or more machine executable instructions or pieces of software, firmware, or a combination thereof. The processor(s) 101 can be semiconductor-based-that is, the processors can include semiconductor material that can perform digital logic. The memory device(s) 103 may include a main memory that stores information in a format that can be read and/or executed by the processor(s) 101. The memory device(s) 103 may store the operating system 105, including the task assistant 110, and the applications 106 including the browser application 108 that, when executed by the processors 101, perform certain operations discussed herein. In some examples, the memory device(s) 103 includes a non-transitory computer-readable medium that includes executable instructions that cause at least one processor (e.g., the processors 101) to execute the operations discussed herein.

The server computer(s) 160 may be computing devices that take the form of a number of different devices, for example a standard server, a group of such servers, or a rack server system. In some examples, the server computer(s) 160 may be a single system sharing components such as processors and memories. In some examples, the server computer(s) 160 may be multiple systems that do not share processors and memories. The network 150 may include the Internet and/or other types of data networks, such as a local area network (LAN), a wide area network (WAN), a cellular network, satellite network, or other types of data networks. The network 150 may also include any number of computing devices (e.g., computers, servers, routers, network switches, etc.) that are configured to receive and/or transmit data within network 150. Network 150 may further include any number of hardwired and/or wireless connections.

The server computer(s) 160 may include one or more processors 161 formed in a substrate, an operating system (not shown) and one or more memory devices 163. The memory device(s) 163 may represent any kind of (or multiple kinds of) memory (e.g., RAM, flash, cache, disk, tape, etc.). In some examples (not shown), the memory devices may include external storage, e.g., memory physically remote from but accessible by the server computer(s) 160. The processor(s) 161 may be formed in a substrate configured to execute one or more machine executable instructions or pieces of software, firmware, or a combination thereof. The processor(s) 161 can be semiconductor-based-that is, the processors can include semiconductor material that can perform digital logic. The memory device(s) 163 may store information in a format that can be read and/or executed by the processor(s) 161. The memory device(s) 163 may store the language model 152 (e.g., the language model 152-1, the language model 152-2), that, when executed by the processor(s) 161, perform certain operations discussed herein. In some examples, the memory device(s) 163 includes a non-transitory computer-readable medium that includes executable instructions that cause at least one processor (e.g., the processor(s) 161) to execute operations.

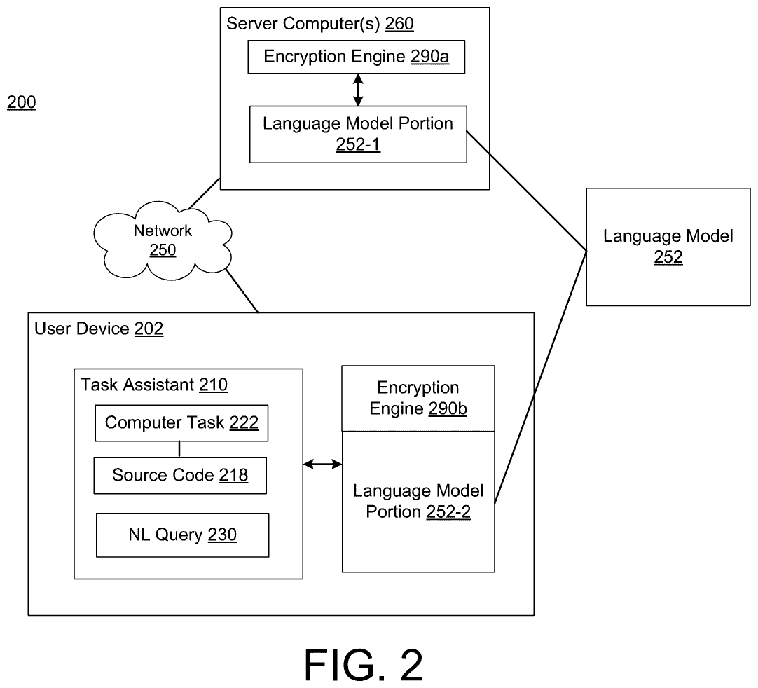

FIG. 2 illustrates a system 200 that enables a user to create and perform a computer task 222 on a user device 202 based on a natural language query 230. The system 200 may be an example of the system 100 of FIGS. 1A through 1G and may include any of the details discussed with reference to those figures. The system 200 includes a user device 202 having a task assistant 210. By distributing language model operations between the user device 202 and the server computer(s) 260, the system 200 may reduce computer resource management (e.g., CPU, memory) associated with executing a language model 252. The language model 252 may include a language model portion 252-1 executable by one or more server computers 260, and a language model portion 252-2 executable by the user device 202.

In some examples, the language model portion 252-2 includes the pre-processing engine 173 of FIGS. 1E and IF. In some examples, the language model portion 252-2 includes the embedding engine 173 of FIG. 1G. In some examples, the user device 202 includes an encryption engine 290b configured to encrypt word embeddings generated by the embedding engine and transmit, over the network 250, the encrypted word embeddings to the language model portion 252-1 executing on the server computer(s) 260. In some examples, the user device 202 does not include an encryption engine 290b. In some examples, the language model portion 252-2 includes the neural network(s) 180 of FIGS. 1G. In some examples, the encryption engine 290b is configured to encrypt the output of the neural network and transmit, over the network 250, the encrypted output for decoding by the language model portion 252-1.

In some examples, the language model portion 252-1 includes the neural network(s) 180 of FIG. 1G. In some examples, the server computer(s) 260 includes an encryption engine 290a configured to decrypt the word embeddings received over the network 250 from the user device 202. In some examples, the server computer(s) 260 does not include an encryption engine 290a. In some examples, the language model portion 252-1 includes the decoder 184 of FIG. 1G (e.g., only the decoder 184 of FIG. 1G). In some examples, the encryption engine 290a is configured to decrypt the output of the neural network received over the network 250 from the user device 202, and the decoder 184, executable by the server computer(s) 260, is configured to generate source code 218 and/or the execution result 166-2, which is transmitted to the user device 202.

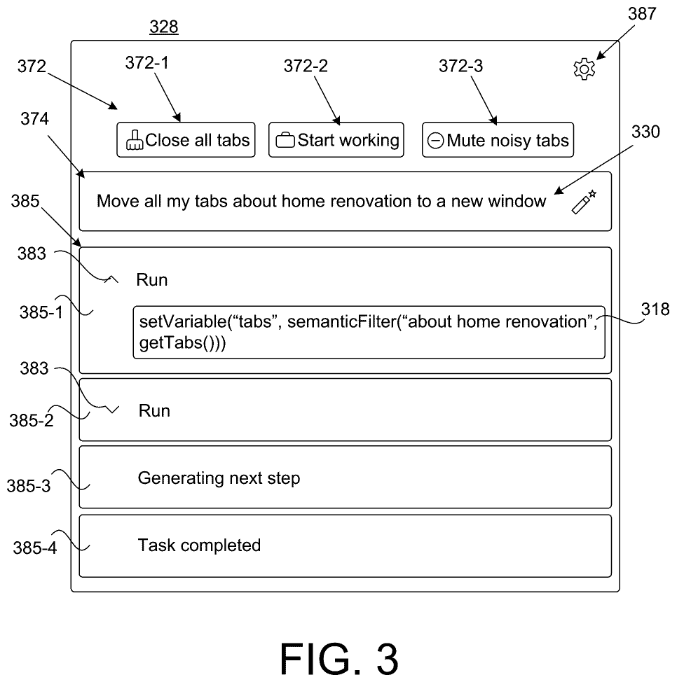

FIG. 3 illustrates an example interface 328 for managing (e.g., creating, re-performing, editing, etc.) computer tasks according to an aspect. The interface 328 may be an example of the interface 128 of FIGS. 1A through 1G and may include any of the details discussed with reference to those figures. As shown in FIG. 3, the interface 328 includes an input field 374 for receiving a natural language query 330 about a request for a computer task to be performed (e.g., “move all my tabs about home renovation to a new window”). In some examples, a user may enter text into the input field 374 to define the natural language query 330. In some examples, the interface 328 may be a user interface configured to receive text via a voice command and may display the text of the voice command in the input field 374. The interface 328 may include an editor control 387, which, when selected, enables the user to modify the existing computer tasks (e.g., select which ones to display, select ones for deletion, etc.).

In some examples, after a particular computer task is generated and performed, the computer task may be stored in a command database (e.g., the command database 124 of FIG. 1A), and the interface 328 may display a UI element 172 corresponding to the new computer task. Since the computer task has already been generated, re-performing the computer task 122 may be processed relatively quickly. For example, as shown in FIG. 3, the interface 328 includes a UI clement 372-1 corresponding to a first computer task, a UI element 372-2 corresponding to a second computer task, and a UI element 372-3 corresponding to a third computer task. The UI elements 372 may be selectable, which causes the underlying computer task to be re-performed.

In response to submission of a natural language query 330, the interface 328 may display status data 385 about the status of generating and executing a computer task during the sequence of steps (e.g., the steps 158 of FIGS. 1A through 1G). For example, the interface 328 may display status data 385-1 (e.g., run) about a first step, status data 385-2 (e.g., run) about second step, status data 385-3 (e.g., generating next step) about a third step, and status data 385-4 (e.g., task complete) when the computer task is completed. In some examples, the status data 385 may include a selectable element 383, which, when selected, displays the underlying source code portion 318 for a particular step. In this manner, a user can view the progress of the computer task generation.

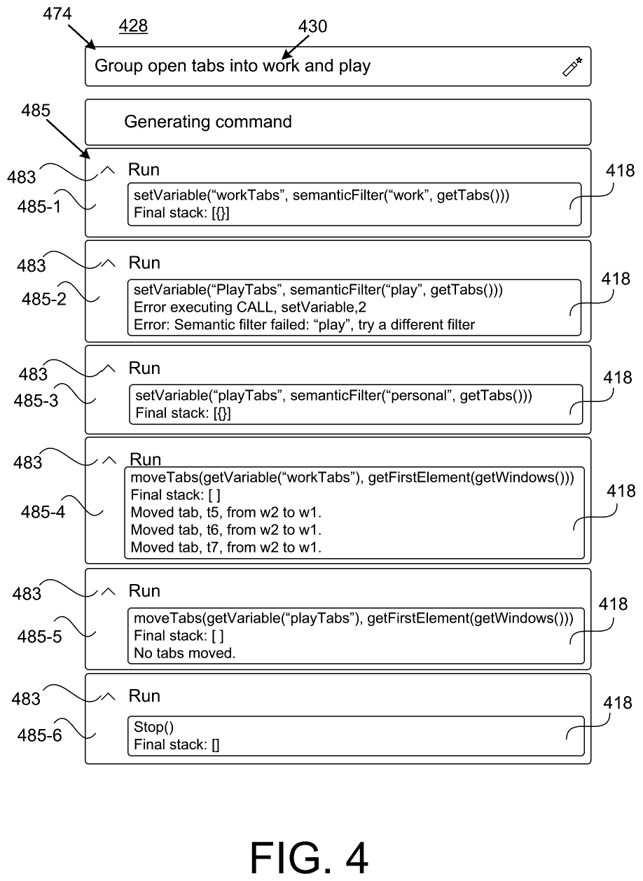

FIG. 4 illustrates an example interface 428 for managing (e.g., creating, re-performing, editing, etc.) computer tasks according to another aspect. The interface 428 may be an example of the interface 128 of FIGS. 1A through 1G and may include any of the details discussed with reference to those figures. As shown in FIG. 4, the interface 428 includes an input field 474 for receiving a natural language query 430 about a request for a computer task to be performed (e.g., “group open tabs into work and play”). In some examples, a user may enter text into the input field 474 to define the natural language query 430. In some examples, the interface 428 may be a user interface configured to receive text via a voice command and may display the text of the voice command in the input field 474.

In response to submission of a natural language query 430, the interface 428 may display status data 485 about the status of generating and executing a computer task during the sequence of steps (e.g., the steps 158 of FIGS. 1A through 1G). For example, the interface 428 may display status data 485-1 (e.g., run) about a first step, status data 485-2 (e.g., run) about second step, status data 485-3 about a third step, status data 485-4 (e.g., run) about a fourth step, status data 485-5 (e.g., run) about a fifth step, and status data 485-6 (e.g., run) about a sixth step. In some examples, the status data 485 may include a selectable element 483, which, when selected, displays the underlying source code portion 418 for a particular step. In this manner, a user can view the progress of the computer task generation and the underlying source code.

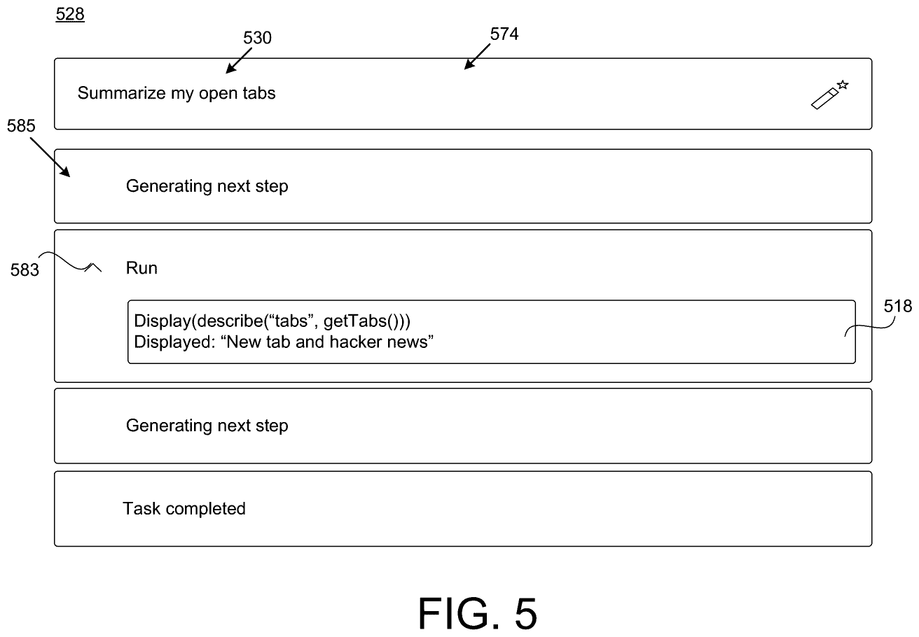

FIG. 5 illustrates an example interface 528 for managing (e.g., creating, re-performing, editing, etc.) computer tasks according to another aspect. The interface 528 may be an example of the interface 128 of FIGS. 1A through 1G and may include any of the details discussed with reference to those figures. As shown in FIG. 5, the interface 528 includes an input field 574 for receiving a natural language query 530 about a request for a computer task to be performed (e.g., “summarize my open tabs”).

In response to submission of a natural language query 530, the interface 528 may display status data 585 about the status of generating and executing a computer task during the sequence of steps (e.g., the steps 158 of FIGS. 1A through 1G). In some examples, the status data 585 may include a selectable element 583, which, when selected, displays the underlying source code portion 518 for a particular step. In this manner, a user can view the progress of the computer task generation and the underlying source code.

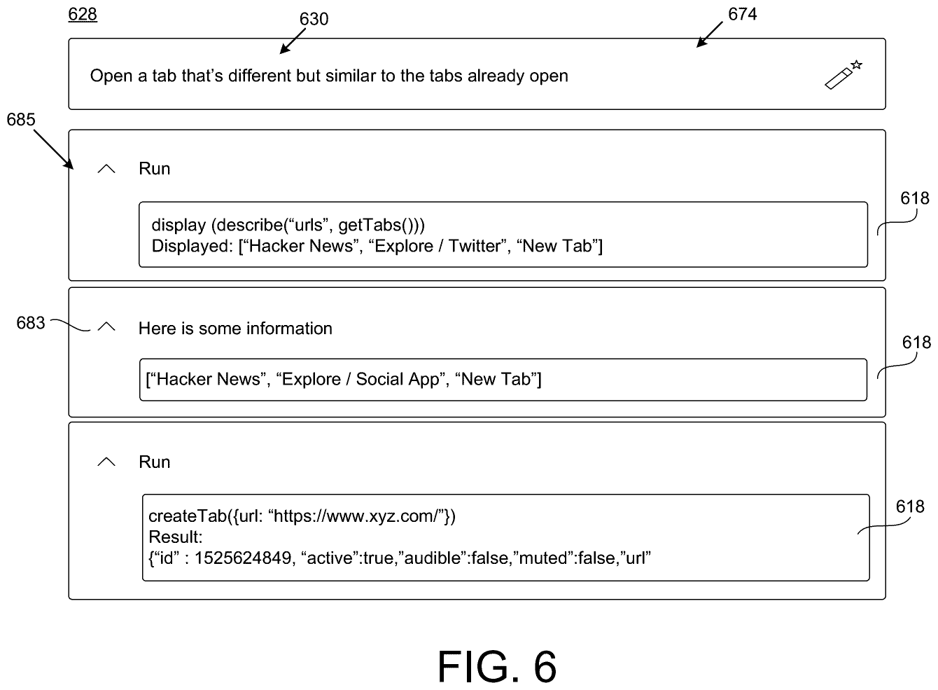

FIG. 6 illustrates an example interface 628 for managing (e.g., creating, re-performing, editing, etc.) computer tasks according to another aspect. The interface 628 may be an example of the interface 128 of FIGS. 1A through 1G and may include any of the details discussed with reference to those figures. As shown in FIG. 6, the interface 628 includes an input field 674 for receiving a natural language query 630 about a request for a computer task to be performed (e.g., “open a tab that's different but similar to the tabs already open”).

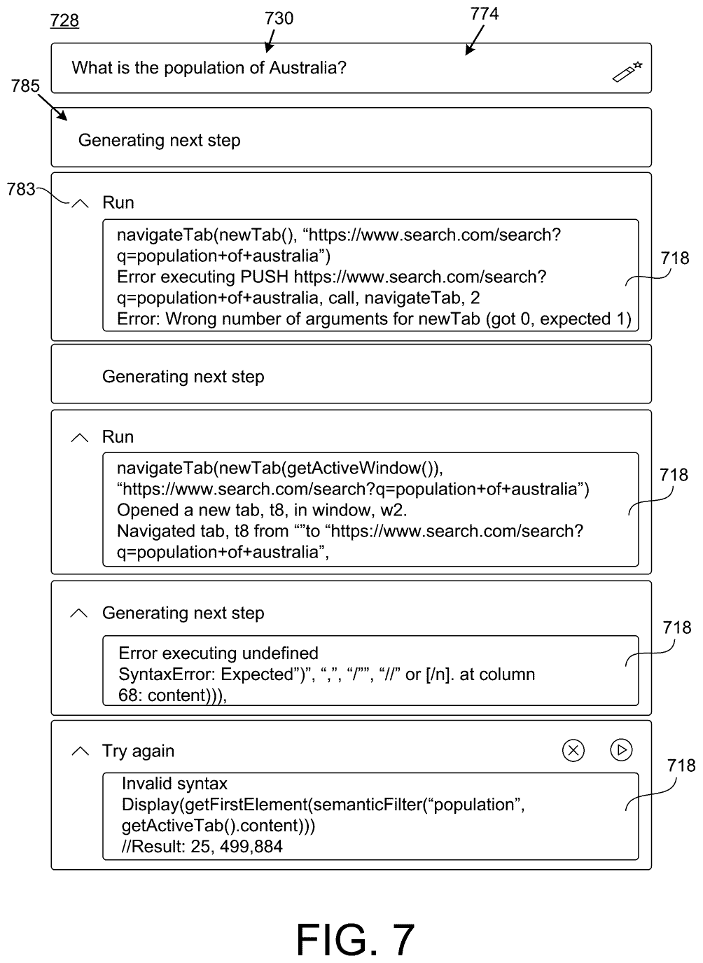

In response to submission of a natural language query 630, the interface 628 may display status data 685 about the status of generating and executing a computer task during the sequence of steps (e.g., the steps 158 of FIGS. 1A through 1G). In some examples, the status data 685 may include a selectable element 683, which, when selected, displays the underlying source code portion 618 for a particular step. In this manner, a user can view the progress of the computer task generation and the underlying source code. In the interfaces shown in FIGS. 6 and 7, the steps of the generated task proceed from the top to bottom.

FIG. 7 illustrates an example interface 728 for managing (e.g., creating, re-performing, editing, etc.) computer tasks according to another aspect. The interface 728 may be an example of the interface 128 of FIGS. 1A through 1G and may include any of the details discussed with reference to those figures. As shown in FIG. 7, the interface 728 includes an input field 774 for receiving a natural language query 730 about a request for a computer task to be performed (e.g., “what is the population of Australia”).

In response to submission of a natural language query 730, the interface 728 may display status data 785 about the status of generating and executing a computer task during the sequence of steps (e.g., the steps 158 of FIGS. 1A through 1G). In some examples, the status data 785 may include a selectable element 783, which, when selected, displays the underlying source code portion 718 for a particular step. In this manner, a user can view the progress of the computer task generation and the underlying source code.

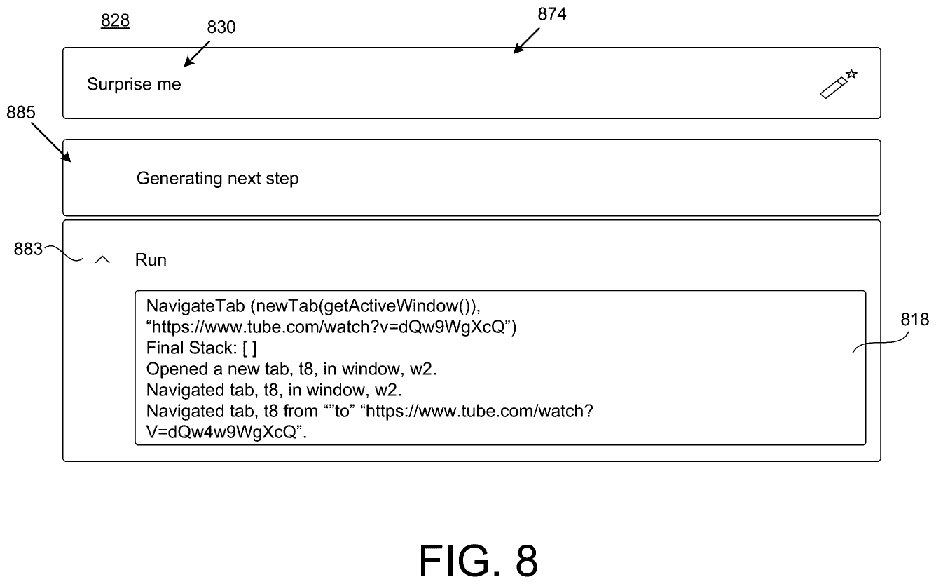

FIG. 8 illustrates an example interface 828 for managing (e.g., creating, re-performing, editing, etc.) computer tasks according to another aspect. The interface 828 may be an example of the interface 128 of FIGS. 1A through 1G and may include any of the details discussed with reference to those figures. As shown in FIG. 8, the interface 828 includes an input field 874 for receiving a natural language query 830 about a request for a computer task to be performed (e.g., “surprise me”).

In response to submission of a natural language query 830, the interface 828 may display status data 885 about the status of generating and executing a computer task during the sequence of steps (e.g., the steps 158 of FIGS. 1A through 1G). In some examples, the status data 885 may include a selectable element 883, which, when selected, displays the underlying source code portion 818 for a particular step. In this manner, a user can view the progress of the computer task generation and the underlying source code.

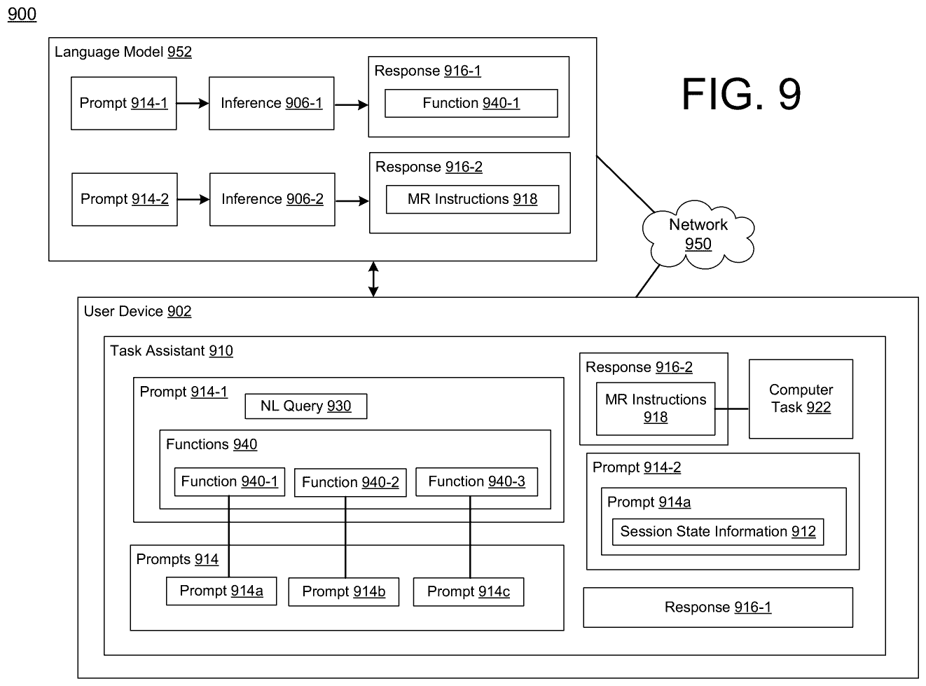

FIG. 9 illustrates a system 900 that enables a user to create and perform a computer task 922 on a user device 902 based on a natural language query 930. In some examples, the system 900 defines a window management feature that can be used to perform computer tasks 922 during a computer session based on natural language queries 930. The user device 902 includes a task assistant 910 that receives a natural language query 930 about a request to perform a computer task 922 and causes a language model 952 to generate machine-readable instructions 918 to perform the computer task 922 on the user device 902 in a manner that is secure, reliable, and/or efficient, which may minimize or reduce the amount of computing resources (e.g., central processing unit (CPU) power, memory) that are typically used for implementing new commands on an operating system of a user device 902.

The system 900 may be an example of the system 100 and/or the system 200 and may include any of the details discussed with reference to FIGS. 1A through 1G and/or FIG. 2. The computer task 922 may relate to managing windows, changing settings, launching applications, and/or searching the web. The system 900 includes a language model 952 that computes an inference 906-1 to identify a function 940 from a list of functions 940 (e.g., a list of predefined functions) that relates to a natural language query 930 and computes an inference 906-2 using a least partially configured prompt (e.g., prompt 914-2) to generate machine-readable instructions 918 for the computer task 922. In some examples, the machine-readable instructions 918 include JSON data (e.g., data in a JSON format) that is used by the task assistant 910 to perform the computer task 922. In some examples, the machine-readable instructions 918 includes a list of JSON identifiers relating to one or more session items (e.g., browser tabs, browser windows, etc.) that are related to one of the functions 940.

For example, in response to a natural language query 930 about a computer task 922, the task assistant 910 may generate a prompt 914-1 that includes the natural language query 930 and a list of functions 940. In some examples, the functions 940 are predefined actions. The functions 940 may include any of the details of the functions 140 of FIGS. 1A through 1G. The functions 940 may include close window, open applications, move windows to several workspaces, mute a tab, find tabs and windows relevant to a query (e.g., find all tabs and windows relevant to a query), and/or change a setting. The task assistant 910 may transmit the prompt 914-1, over a network 950, to the language model 952. In response to the prompt 914-1, the language model 952 may compute an inference 906-1 to identify which of the functions 940 relate to the natural language query 930. In other words, the language model 952 may determine which function 940 (e.g., single function) from the list of functions 940 that is most related to the natural language query 930. If the language model 952 determines that no function 940 is related to the natural language query 930, the language model 952 may return a response 916-1 that indicates that no function is related to the natural language query 930. In some examples, the language model 952 may identify that function 940-1 relates to the natural language query 930. The language model 952 may generate and transmit a response 916-1 that identifies the function 940-1.

In response to the response 916-1, the task assistant 910 may obtain a prompt 914a that is tailored for the function 940-1. For example, the task assistant 910 may store a plurality of prompts 914 that are function specific. Each prompt 914 may include textual instructions that request that the language model 952 obtain machine-readable instructions 918 about one or more session items relating to a particular function 940. For example, the prompts 914 may include a prompt 914a that corresponds to the function 140-1, a prompt 914b that corresponds to the function 940-2, and a prompt 914c that corresponds to the function 940-3. Although three prompts 914 and three functions 940 are depicted in FIG. 9, the system 900 may include any number of prompts 914 and functions 940. Since the natural language query 930 relates to the function 940-1, the task assistant 910 may generate a prompt 914-2 that includes the prompt 914a, the natural language query 930, and session state information 912 about the user's computing session. The session state information 912 may include any of the information discussed with reference to the session state information 112 of FIGS. 1A through 1G.

The task assistant 910 may transmit the prompt 914-2 requesting that the language model 952 generate machine-readable instructions 918 that implement the function 940-1 using the session state information 912. In response to the prompt 914-2, the language model 952 may compute an inference 906-2 to generate the machine-readable instructions 918. The prompt 914-2 may include at least a portion of the session state information 912 about the user's computing session, the natural language query 930, and a request to return a JSON list related to the underlying action of the function 940-1. If the prompt 914-2 relates to closing one or more windows, the prompt 914-2 may include information that indicates that the user has some windows and tabs that are open (which may be formatted in JSON), the natural language query 930, and a request to return a JSON list of identifiers related to the windows and tabs that are to be closed. The language model 952 may transmit a response 916-2 to the task assistant 910, where the response 916-2 includes the machine-readable instructions 918. The task assistant 910 may execute the machine-readable instructions 918 to perform the computer task 122.

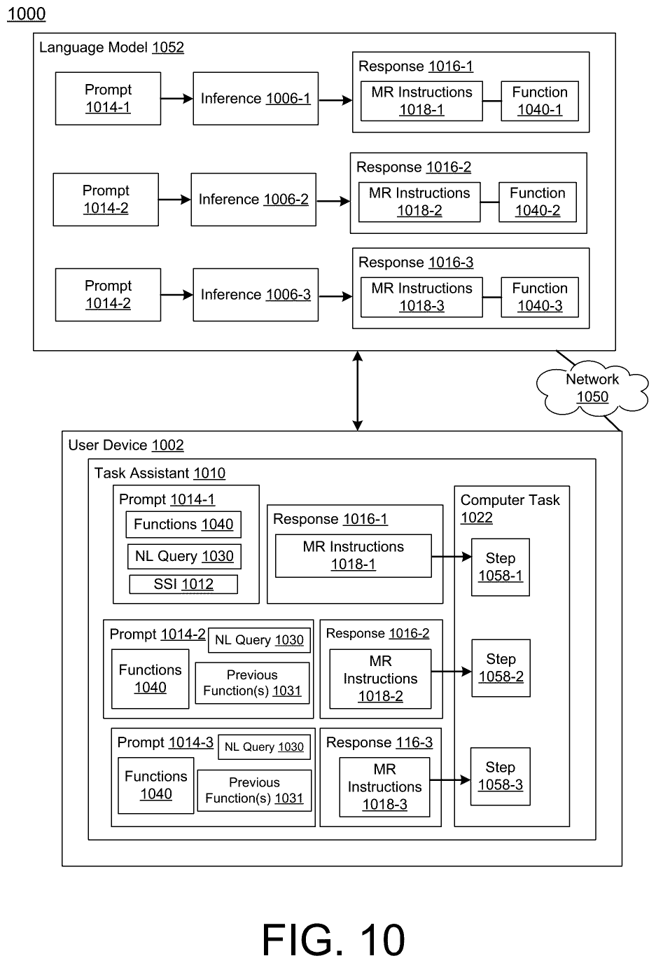

FIG. 10 illustrates a system 1000 that enables a user to create and perform a computer task 1022 on a user device 1002 based on a natural language query 1030. In some examples, the system 1000 defines a window management feature that can be used to perform computer tasks 1022 during a computer session based on natural language queries 1030. The user device 1002 includes a task assistant 1010 that receives a natural language query 1030 about a request to perform a computer task 1022 and causes a language model 1052 to generate machine-readable instructions (e.g., 1018-1, 1018-2, 1018-3) to perform the computer task 1022 on the user device 1002 in a manner that is secure, reliable, and/or efficient, which may minimize or reduce the amount of computing resources (e.g., central processing unit (CPU) power, memory) that are typically used for implementing new commands on an operating system of a user device 1002. The system 1000 may be an example of the system 100 and/or the system 200 and may include any of the details discussed with reference to FIGS. 1A through 1G and/or FIG. 2. The computer task 1022 may relate to managing windows, changing settings, launching applications, and/or searching the web. The system 1000 includes a language model 1052 configured to sequentially generate machine-readable instructions for steps of a computer task 1022.

For example, in response to a natural language query 1030 about a computer task 1022, the task assistant 1010 may generate a prompt 1014-1 that includes the natural language query 1030, a plurality of functions 1040, and session state information 1012 about a user's computer session. The functions 1040 may include close a window, open applications, move windows to several workspaces, mute a tab, find tabs and windows relevant to a query (e.g., find all tabs and windows relevant to a query), and/or change a setting. The session state information 1012 may include information about the user's computing session (e.g., which windows and/or tabs are opened, etc.). The session state information 1012 may include any of the information discussed with reference to the session state information 112 of FIGS. 1A through 1G.

The task assistant 110 may transmit, over a network 1050, the prompt 1014-1 requesting that the language model 1052 generate machine-readable instructions 1018-1 using one function (e.g., function 1040-1). In response to the prompt 1014-1, the language model 1052 may compute an inference 1006-1 to generate machine-readable instructions 1018-1 for implementing a function 1040-1. The language model 1052 may transmit a response 1016-1 to the task assistant 1010, where the response 1016-1 includes the machine-readable instructions 1018-1 for the function 1040-1. In response to the response 1016-1, the task assistant 1010 may execute the machine-readable instructions 1018-1 to perform a step 1058-1 of the computer task 1022. In some examples, the machine-readable instructions 1018-1 include JSON data.

In response to completion of the step 1058-1, the task assistant 1010 may generate a prompt 1014-2 that includes the natural language query 1030, the function 1040, and any previous function(s) 1031 that were executed. The task assistant 1010 may transmit the prompt 1014-2 requesting that the language model 1052 generate machine-readable instructions 1018-2 for the next function (e.g., function 1040-2). In response to the prompt 1014-2, the language model 1052 may compute an inference 1006-2 that generates machine-readable instructions 1018-2 that implements a function 1040-2. The language model 1052 may transmit a response 1016-2 to the task assistant 1010, where the response 1016-2 includes the machine-readable instructions 1018-2 for the function 1040-2. In response to the response 1016-2, the task assistant 1010 may execute the machine-readable instructions 1018-2 to perform a step 1058-2 of the computer task 1022.

In response to completion of the step 1058-2, the task assistant 1010 may generate a prompt 1014-3 that includes the natural language query 1030, the function 1040, any previous function(s) 1031 that were executed. The task assistant 1010 may transmit the prompt 1014-3 requesting that the language model 1052 generate machine-readable instructions 1018-3 for the next function (e.g., function 1040-3). In response to the prompt 1014-3, the language model 1052 may compute an inference 1006-3 that generates machine-readable instructions 1018-3 that implements a function 1040-3. The language model 1052 may transmit a response 1016-3 to the task assistant 1010, where the response 1016-3 includes the machine-readable instructions 1018-3 for the function 1040-3. In response to the response 1016-3, the task assistant 1010 may execute the machine-readable instructions 1018-3 to perform a step 1058-3 of the computer task 1022. Although three steps are depicted in FIG. 10, the system 1000 may perform any number of steps, including two steps or any number of steps greater than three.

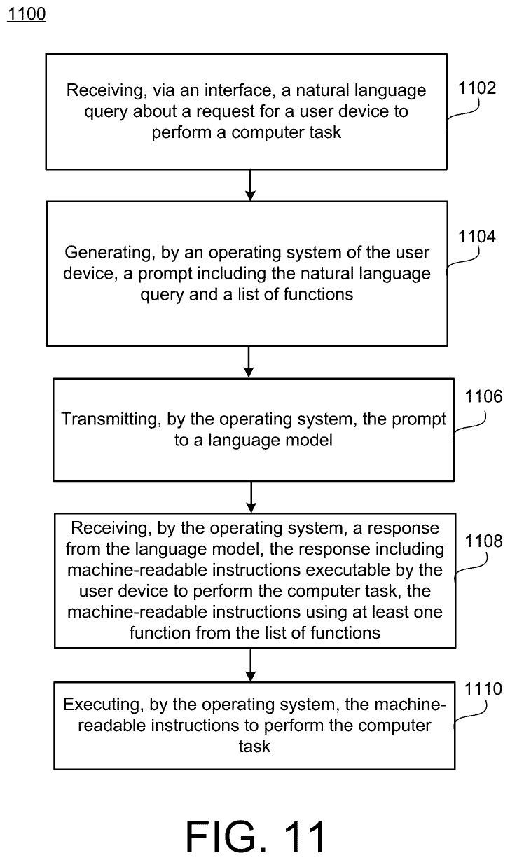

FIG. 11 is a flowchart 1100 depicting example operations of a system for generating and performing a computer task based on a natural language query. The flowchart 1100 may depict operations of a computer-implemented method. Although the flowchart 1100 is explained with respect to the system 100 of FIGS. 1A through 1G, the flowchart 1100 may be applicable to any of the implementations discussed herein, including the system 900 of FIG. 9 and/or the system 1000 of FIG. 10. Although the flowchart 1100 of FIG. 11 illustrates the operations in sequential order, it will be appreciated that this is merely an example, and that additional or alternative operations may be included. Further, operations of FIG. 11 and related operations may be executed in a different order than that shown, or in a parallel or overlapping fashion. The flowchart 1100 may depict a computer-implemented method.

The operations discussed herein may initiate the generation of machine-readable instructions to implement a wide range of computer tasks based on natural language queries to manage their computing session with less user interaction than conventional management techniques. In some examples, the operations discussed herein may enable the operating system to implement new user-customized computer tasks without requiring a code update to implement the new-customized computer tasks. For example, to enable a user to select a single command (or operate a single control) that programmatically groups work tabs in a new browser window, a code developer may create and test machine-readable instructions and include the machine-readable instructions in an installation update to the operating system, and the installation update is installed on the user devices, which may require a relatively large amount of computer resources (e.g., central processing unit (CPU) power, memory) since the installation update would be applied to the devices (e.g., all devices) running the operating system. However, the system discussed herein may enable the user to implement a wide range of computer tasks (not previously included on the user device) that may avoid costly installation updates, thereby minimizing or reducing the amount of computing resources for implementing new computer tasks on user devices.

Operation 1102 includes receiving, via an interface 128, a natural language query 130 about a request for a user device 102 to perform a computer task 122. Operation 1104 includes generating, by an operating system 105 of the user device 102, a prompt 114-1 including the natural language query 130 and a list of functions 140. Operation 1106 includes transmitting, by the operating system 105, the prompt 114-1 to a language model 152. Operation 1108 includes receiving, by the operating system 105, a response 116-1 from the language model 152, the response 116-1 including machine-readable instructions executable by the user device 102 to perform the computer task 122, the machine-readable instructions using at least one function 140 from the list of functions 140. Operation 1110 includes executing, by the operating system 105, the machine-readable instructions to perform the computer task 122. In some examples, the machine-readable instructions include the source code 118. In some examples, the machine-readable instructions include the machine-readable instructions 918. In some examples, the machine-readable instructions include the machine-readable instructions 1018.

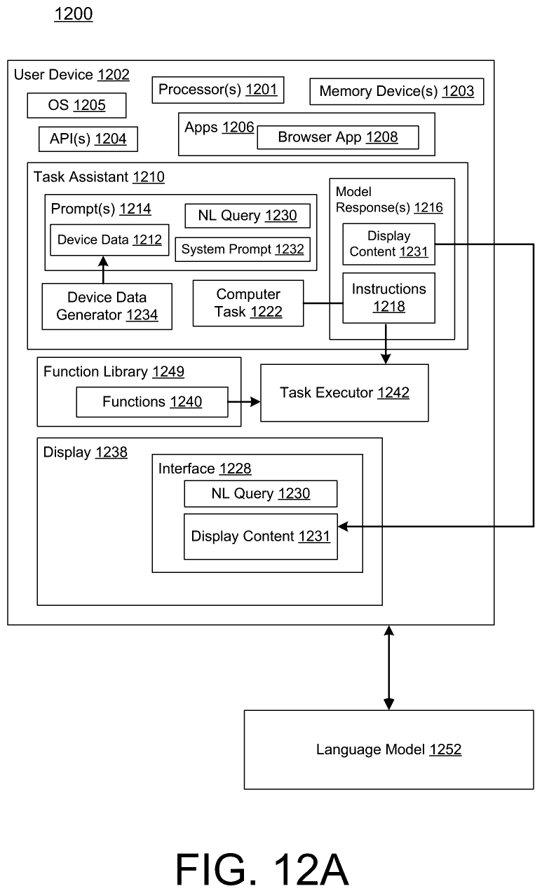

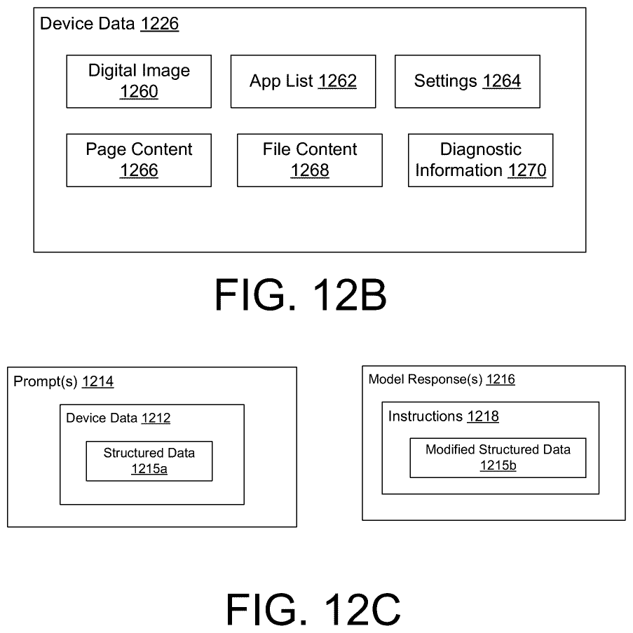

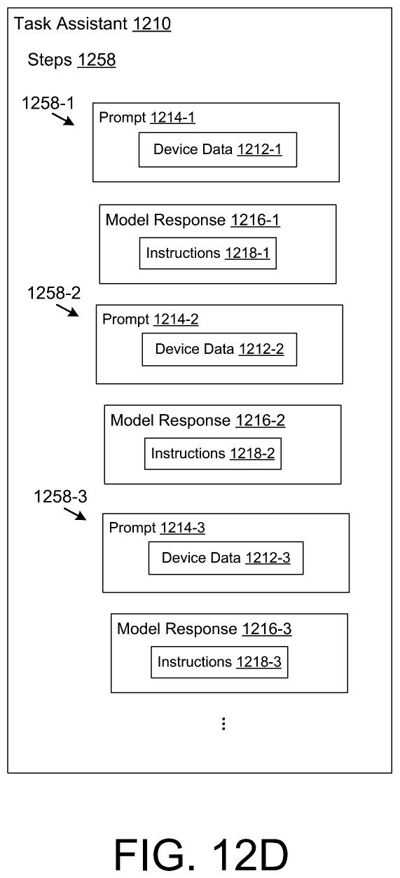

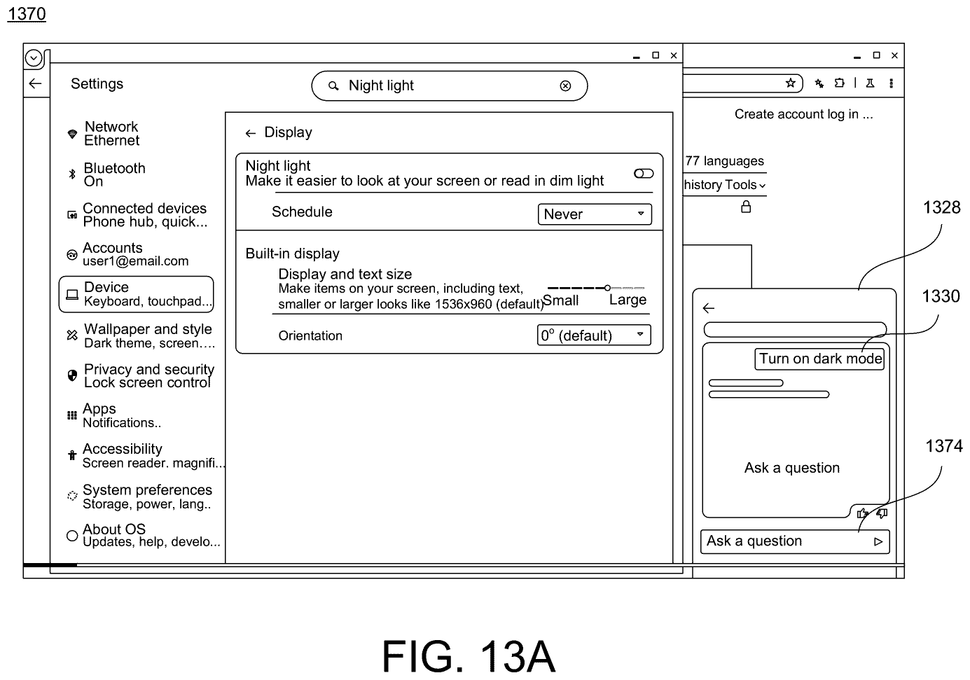

FIGS. 12A through 12D illustrate a system 1200 with a task assistant 1210 on a user device 1202 that creates and performs a computer task 1222 on a user device 1202 using a language model 152 according to another aspect. The computer task 1222 may be automated action(s) that are performed without prompting from the user (e.g., other than the submission of a natural language query 1230). The system 1200 may be an example of the system 100 of FIGS. 1A through 1G, the system 200 of FIG. 2, and/or the system 1000 of FIG. 10 and may include any of the details discussed with reference to those figures. In some examples, the task assistant 1210 may render an interface 1228 on a display 1238 of the user device 1202. In some examples, the interface 1228 is a dialogue pane. A user may submit natural language queries 1230 to implement a variety of computer tasks 1222 such as open applications 1206, execute cursor commands (e.g., click at a given coordinate) (e.g., without using an input device such as a computer mouse or touch screen), keyboard entry (e.g., text and keyboard shortcuts), open files, edit files, create new files, change settings 1264, open specific web pages in one or more browser tabs, highlight certain parts of the display 1238, troubleshoot issues on the user device 1202, and/or perform window management tasks (e.g., organize windows), etc.

In some examples, the computer tasks 1222 include device actions such as edit files, open files in a photo and video manager application, change settings, open specific pages in a browser tab, open applications, highlight certain parts of the display 1238, file actions such as copy and/or move files, create files, launch files within a files application, window management actions such as reorganize browser tabs, windows, and/or desks, delete tabs, setting actions (e.g., may change Boolean, integer, and/or string settings, activate or deactivate a focus mode setting, application actions such as open applications, close applications, or navigate to certain interfaces in an application, UI automation events such as clicking on a particular coordinate on the screen and/or automatic keyboard entry of text. In some examples, the computer tasks 1222 may include performing an action on a node of an accessibility data structure (e.g., an accessibility tree) of the operating system 1205. The accessibility data structure may be a hierarchical data structure that represents the UI elements on the screen and their relationships for assistive technologies. Each node in the accessibility data structure may represent a UI element, and each node may contain attributes that describe the element (e.g., label like “button”, “text”, “link”, text, state, value, bounds, relationship, etc.). The actions can include click, scroll up or down and focus.

A computer task 1222 may be a step or sequence of steps executable by a

computer not yet implemented on the user device 1202. For example, the operating system 1205 and/or the browser application 1208 may include individual commands (e.g., shortcut keys) or user controls that enable the user to perform some actions with respect to settings, applications, UI interactions, etc. However, these preexisting commands or controls may be limited, which can cause the user to perform multiple actions to accomplish a particular computer task. A computer task 1222 may include a sequence of multiple operations such as opening an application or a file, programmatically performing a clicking operation, inserting data into a text box, and saving the file. The task assistant 1210 may allow the user to generate a customized command (e.g., the computer task 1222) using a natural language query 1230, which may enable the generation of a wide variety of computer tasks 1222 that were previously not defined by the operating system 1205. In some examples, the task assistant 1210 may enable the user to create customized keys (e.g., shortcut keys) for user-defined functions that are executable by the operating system 1205 and/or the language model 1252 based on natural language queries 1230.

In some examples, a user may submit natural language queries 1230 via the interface 1228 to interface with a language model 1252 to answer and discuss general knowledge questions, aggregate and summarize information (e.g. into a doc report or pdf), collaborate with the user on tasks on the computer (e.g. polish these slides), undertake complex actions in the computer relatively autonomously, and/or troubleshoot issues with the user device 1202. In some examples, the task assistant 1210 may be used to answer “how do I” questions. For example, a user may submit a query such as “How do I add notes to a PDF”, and the language model 152 may answer this question (e.g., display content 1231), and the task assistant 1210 may use instructions 1218 from a model response 1216 to highlight in a user interface which controls the user may check next to go through the workflow to add notes to a PDF. In another example, a user may submit a query “how do I scan” or “how do I turn on the screen reader”, and the language model 152 may answer these queries, and the task assistant 1210 may use instructions 1218 from a model response 1216 may render one or more interfaces (e.g., in a sequence) and visually highlight one or more items on the interface(s) to assist the user to enable these computer tasks 1222.

In some examples, a user may submit a natural language query 1230 to perform window management such as grouping certain windows, moving windows relating to a certain type of category to a new desktop, or other actions such as open all my windows or setup my workspace for task X (e.g., going through my email or starting a new coding session, etc.). In some examples, the task assistant 1210 may generate a recap of the last session to prompt the user to open up certain workstreams. In some examples, the task assistant 1210 may alter device settings. In some examples, the task assistant 1210 may be used to perform a comparison of open tab content. For example, if a user has a few open tabs of product headphones for purchase, then the task assistant 1210 may operate with the language model 1252 to provide a comparison of the headphone options. In some examples, the task assistant 1210 may enable question and answer on files on the user device 1202 (e.g., may include file information like time modified to answer time related questions, may include queries on images on device, or in particular folder such as “What was the name of the cliffs I went to in Ireland?”, “Find me my passport photo”, etc.).

In some examples, the task assistant 1210 may operate with the language model 1252 may enable question and answer about a current video conference call or a video on a video distribution or steaming platform or a local video (e.g., may provide timestamps for all main aspects of the video, may answer questions like “Which product has the best value?” for a review video, “what song is playing in this video?”). In some examples, the task assistant 1210 may perform one or more file actions (e.g., “convert this jpeg into a png” or “rotate this photo”, “upright this scanned PDF’). In some examples, the task assistant 1210 may enable the troubleshooting of the user device 1202 (e.g., query—“Why is my device so slow?”, model response—“because RAM is at 95% capacity. Some potential options to resolve this could be to close some unused tabs or apps. Right now you have 30 open tabs.”

The task assistant 1210 provides an interface 1228 on a display 1238 of the user device 1202. The interface 1228 includes an input field for receiving the natural language query 1230. In some examples, a user may enter text into the input field to define the natural language query 1230. In some examples, the interface 1228 may be a user interface configured to receive text via a voice command and may display the text of the voice command in the input field. In some examples, the interface 1228 includes a UI object. In some examples, the interface 1228 may be fixed to a location on the display 1238 and/or may move to other portions of the display 1238. The task assistant 1210 may render the interface 1228. In some examples, the task assistant 11210 may render the interface 1228 in response to a selection of a UI element, such as launching the task assistant 1210. In some examples, the interface 1228 is a user interface of the operating system 1205.

In response to submission of a natural language query 1230, the task assistant 1210 generates a prompt 1214 for the language model 152. The prompt 1214 includes the natural language query 1230 and device data 1212. In some examples, the device data 1212 is an example of the session state information 112 of FIGS. 1A to 1G and may include any of the details discussed with reference to the session state information 112. The task assistant 1210 includes a device data generator 1234 configured to generate the device data 1212. In some examples, in response to the submission of the natural language query 1230, the device data generator 1234 may generate the device data 1212 and may include the device data 1212 in the prompt 1214.

As shown in FIG. 12B, the device data 1212 may include a digital image 1260 of the display 1238. The digital image 1260 may be a screenshot of the display 1238. In other words, the digital image 1260 may be a picture of the device's display. In some examples, the device data 1212 may include an application list 1262. The application list 1262 may include a list of application identifiers of applications 1206 that are currently available on the user device 1202. In some examples, the application identifiers include resource locators (e.g., uniform resource locator (URLs) of the applications. In some examples, the application list 1262 includes a list of webpages rendered in open browser tabs (or a list of a history of webpages in the browser tabs). In some examples, the application list 1262 includes a list of available applications 106 that are available (e.g., opened or not opened) on the user device 1202. In some examples, the device data 1212 may include accessibility tree data (also referred to as accessibility data structure data). The accessibility tree data may include a root node with child nodes of visible open windows (e.g., all visible open windows). The accessibility tree data may also include system UI and non-visible systems which are available within the operating system 1205.

In some examples, the device data 1226 includes a list of available settings 1264. A setting 1264 may be an adjustment within a program or hardware device to customize the program or the device. A setting 1264 may control how a program or device functions or appears. In some examples, the settings 1264 are operating system settings, e.g., accessible via an operating system setting interface. In some examples, the settings 1264 are browser settings, e.g., accessible via a browser setting interface. In some examples, the settings 1264 are settings of a specific application 1206 executable by the operating system 1205. A setting 1264 may be defined by a name or title and a Boolean data value, a data string, an integer, and/or a list or array, or a custom data type. In some examples, the device data 1226 includes page content 1266 of a webpage rendered within an open browser tab. In some examples, the device data 1226 includes all the page content 1266 of any open browser tab. In some examples, the device data 1226 includes file content 1268 of a plurality of files stored on the user device 1202. In some examples, the file content 1268 includes the content of any files stored on the user device 1202. The file content 1268 may include video, audio, and/or text of files stored on the user device 1202. In some examples, the file content 1268 includes content of files (e.g., all files) on disk, including images, video and audio.

In some examples, the device data 1226 includes diagnostic information 1270 about the user device 1202. The diagnostic information 1270 may include performance information about the processors 101, battery, and/or the memory devices 1203 on the user device 1202. In some examples, the diagnostic information 1270 may include information about a battery health, cycle count, battery charge percentage, and/or battery time. In some examples, the diagnostic information 1270 may include information about the storage such as an amount of free storage, a total amount of storage, an amount of storage relating to files, applications, offline files, browsing data. In some examples, the diagnostic information 1270 may include information about the CPU such as a CPU usage snapshot, temperature, and/or current clock speed. In some examples, the diagnostic information 1270 may include information about RAM usage.

In some examples, the task assistant 1210 includes a system prompt 1232 includes the prompt 1214. The system prompt 1232 may be a predefined prompt with information that helps the language model 152 generate a model response 1216. In some examples, the task assistant 1210 determines a type (or category) of the underlying task and includes a system prompt 1232 that corresponds to the type or category. In some examples, the task assistant 1210 communicates with the language model 2052 to determine the type or category of the underlying task. For example, the task assistant 1210 may generate and transmit an initial prompt with the natural language query 1230 with a request to identify the type of underlying task of the natural language query 1230 and receives a model response that identifies the type or category of task. In some examples, the type or category of tasks includes a help (or generic) task, a setting task, a diagnostics task, a window management task, or a file management task. If it is determined that the task is a help task, the task assistant 1210 may insert a system prompt 1232 that corresponds to the help task. If it is determined that the task is a setting task, the task assistant 1210 may insert a system prompt 1232 that corresponds to the setting task, and so forth.

In some examples, the type (and amount) of device data 1226 may depend on the underlying task. For example, for a help task, the prompt 1214 may include a screenshot of the current screen, content from an active tab, and a list of desks (e.g., virtual desktops), windows, and tabs (e.g., browser tabs). For a setting task, the prompt 1214 may include a list of all settings and their options. For a diagnostics task, the prompt 1214 may include current diagnostic information from the related services, and a list of desks, windows, and tabs. For a window management task, the prompt 1214 may include a list of all open windows and tabs. For a file management task, the prompt 1214 may include a list of all files on the device and/or content from specific or all files on the device.

The task assistant 1210 transmits the prompt 1214 to the language model 1252. In response to the prompt 1214, the language model 1252 generates a model response 1216 that responds to the natural language query 1230 using the device data 1212 and the system prompt 1232. The model response 1216 includes instructions 1218 that, when executed by a task executor 1242, performs a computer task 1222. In some examples, the model response 1216 includes display content 1231 that is displayed on the interface 1228. For example, if the natural language query 1230 is “turn on dark mode”, the display content 1231 may be “dark mode is enabled” and the instructions 1218 may be the data that enables the task executor 1242 to change a display setting to the dark mode.

In some examples, the instructions 1218 includes system instructions to be executable by one or more functions 1240 defined by a system library 1249. The functions 1240 may be any type of operating system function executable by an operating system 1205. In some examples, the functions 1240 are operating system application programming interfaces (APIs).

In some examples, the functions 1240 includes operations executable by the language model 1252 itself. Execution of a function 1240 may include retrieving (or transmitting) data from (to) an application or performing a certain action. In some examples, the functions 1240 include one or more operations that may be executed by another language model. For example, a certain application (App1) (e.g., a website or native application) may have their own assistant (e.g., another language model) that is specifically-tuned or trained to have a better understanding of the application's functionality. In response to a natural language query 1230 (e.g., “subscribe to X on App1”), the task assistant 1210 may cause the language model 1252 to generate instructions 1218 that causes the operating system 1205 to open a new tab with App1.com and delegates a function (e.g., the subscribe-to-x request) to App1's assistant.

In some examples, the functions 1240 include application programming interface (API) functions calls to interact with (e.g., retrieve from, transmit data to, or perform a specific action on) an application 1206 (e.g., a browser application 1208, another application 1206, or the operating system 1205 itself). In some examples, the functions 1240 include operations that enable the operating system 1205 (e.g., the task assistant 1210) to interact with and/or control aspects of an application 1206 (e.g., a browser application 1208, another application 1206, or the operating system 1205 itself). Some examples of functions 1240 includes API function calls for obtaining a list of browser tabs, obtaining a list of browser windows, obtaining a list of browser tabs in browser windows, obtaining a list of browser windows that include browser tabs, obtaining a subset of tabs that semantically match a search criteria, closing one or more browser tabs, closing one or more browser windows, and/or opening a new browser tab with a resource locator (e.g., URL), among others.

The language model 1252 used herein is, for example, a conventional large language model, e.g., based on a transformer architecture, adapted to generate text in response to a text prompt provided as input. Such large language models are commonly known as LLMs. Such LLMs are trained on a large corpus of publicly available text, e.g., content from public databases and websites. In some cases, the LLM can be part of the operating system 12105, so that function calls to the operating system 1205 can be implemented using the LLM. In some examples, the language model 1252 is a multi-modality language model that can receive text, image, and/or video as inputs.

In some examples, the instructions 1218 may be input data that is used by a function 1240. In some examples, a function 1240 is a UI interaction function (e.g., a click function) that receives coordinates on a display 1238 and executes a cursor click on those coordinates. In some examples, the instructions 1218 includes the click coordinates. In some examples, a function 1240 is an open application function, where the instructions 1218 include identifies the open application function and the application identifier of the application 1206 to be opened.

In some examples, referring to FIG. 12C, the device data 1212 includes structured data 1215a. The structured data 1215a may include a data structure about windows that are opened on the user device 1202 such as a list of window identifiers, any resource identifiers for webpages rendered in the window identifiers, and their association with any virtual desks. In some examples, the structured data 1215 includes a protocol structure. In some examples, the structured data 1215 includes a protocol structure for window management. In some examples, the structured data 1215 includes a protocol structure for settings 1264. In some examples, the protocol structure for settings 1264 includes protocol buffers that define the settings and their configuration options such as Booleans for on/off, strings for text, integers for values, etc. In some examples, referring to FIG. 12C, the model response 1216 includes modified structured data 1215b. The modified structured data 1215b is an altered version of the structured data 1215a. In the case of settings 1264, the modified structured data 1215b includes protocol buffers for a setting with the new configuration option (e.g., a different Boolean, or string, or integer).

In some examples, as shown in FIG. 12D, the task assistant 1210 (in conjunction with the task executor 1242) may perform the computer task 122 in a sequence of steps 1258 (e.g., a multi-step operation). For example, the task assistant 1210 may transmit a sequence of prompts 1214, thereby receiving a sequence of instructions 1218 that implement the computer task 1222 in a step by step manner. For example, in response to the natural language query 1230, the task assistant 1210 may generate and send a prompt 1214-1 with device data 1212-1, and then receive a model response 1216-1 with instructions 1218-1 that implement a step 1258-1 of the computer task 1222. Then, the task assistant 1210 may generate and send a prompt 1214-2 with device data 1212-2, and then receive a model response 1216-2 with instructions 1218-2 that implement a step 1258-2 of the computer task 1222. Then, the task assistant 1210 may generate and send a prompt 1214-3 with device data 1212-3, and then receive a model response 1216-3 with instructions 1218-3 that implement a step 1258-3 of the computer task 1222. If natural language query 1230 relates to “create a new doc and write the top ten animals in Australia and saved the doc file”, step 1258-1 may relate to opening a new text file, step 1258-2 may relate to clicking in the text box and inserting the text (e.g., top ten animals in Australia), and step 1258-3 may relate to saving the file.

In some examples, the task assistant 1210 may operate in a multi-step process (e.g., a two-step process), with an initial call to the model determining the correct task to use, and then a subsequent call to execute the chosen task. Each task has a different set of system instructions and may require additional information from the user device 1202. The initial tasks available may be the help task, the diagnostics task, the files task, the window management task and the settings task.

The response back from the language model 1252 to the user device 1202 may contain either a final response to show to the user, with potentially an action attached, or the response may be a request for additional information from the device. If additional information from the user device 1202 is requested, then this will lead to an additional call to the language model 1252 with the new context. In some examples, the query plus most of the system context may be sent to the server (e.g., the language model 1252) in the initial request. In some examples, the only information not sent will be all files on device and diagnostics data. This is because collecting and sending all of this information could take a while and may limit the latency of the system. If the task selected does not require this additional information, then an additional round trip back to the user device 1202 may not be required. Thus, the response back to the user device 1202 for these queries may be a response to the user plus potentially an action to execute on. In some examples, the task assistant 1210 may execute an n-step solution (e.g., as shown in FIG. 12D), which may allow the planner to request for a series of actions to be constructed. It could also allow for actions which require more than one system on the user device 1202 to execute, e.g., “make a file with details on how much storage I've used”. The response back from the language model 1252 may be a graph of actions to execute.

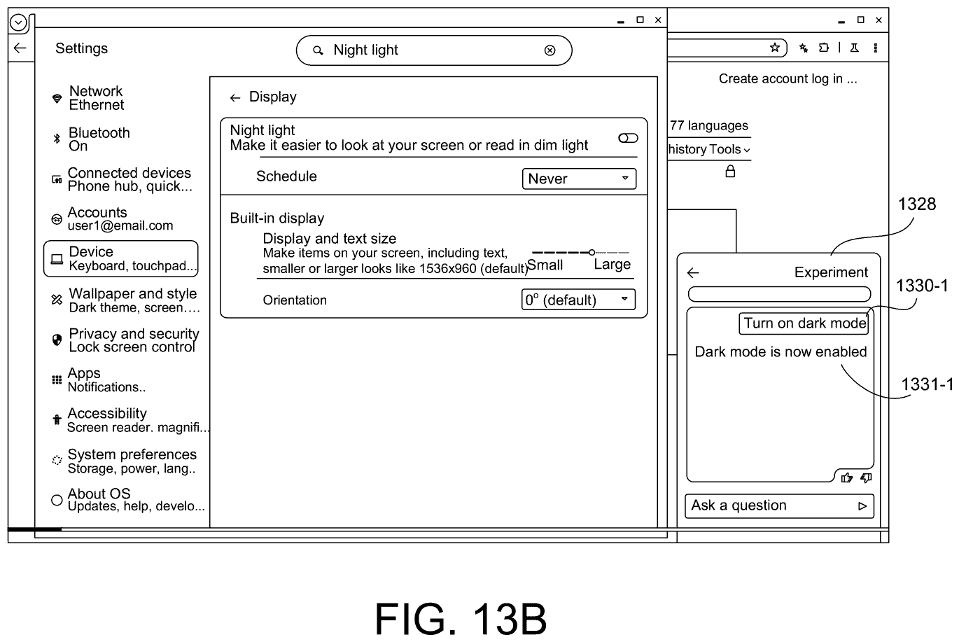

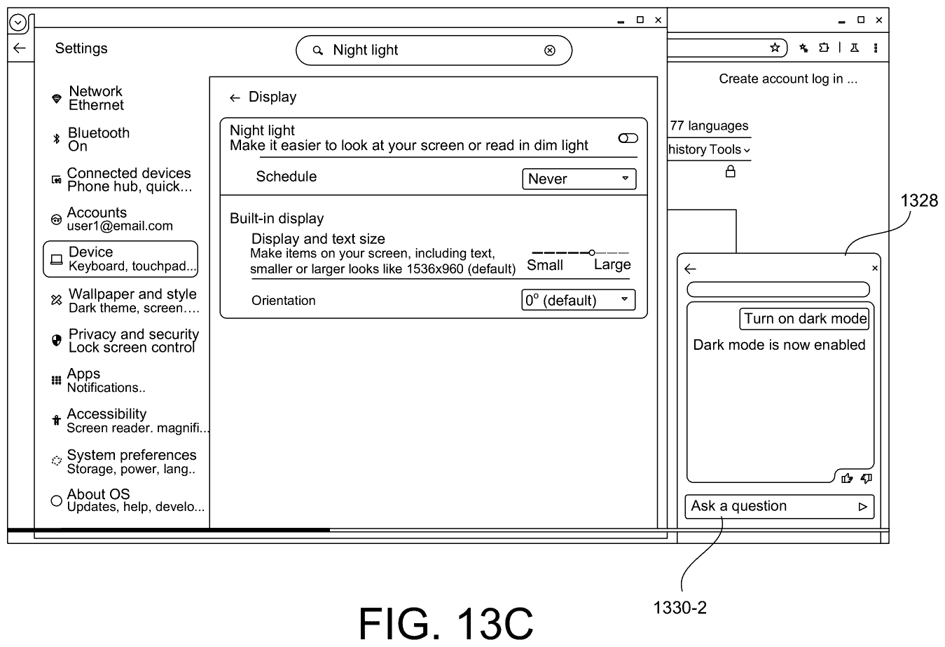

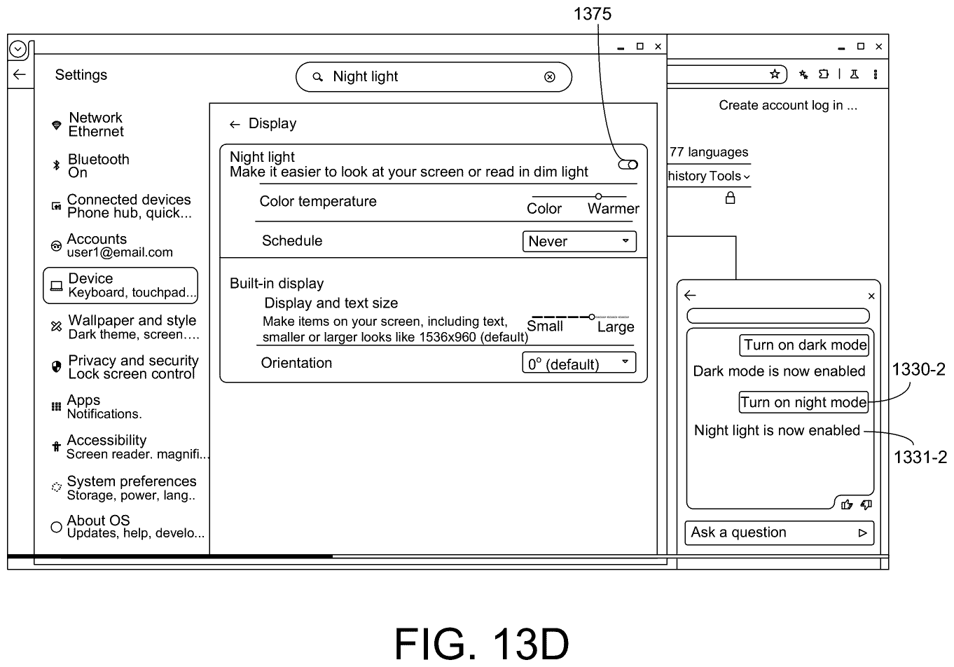

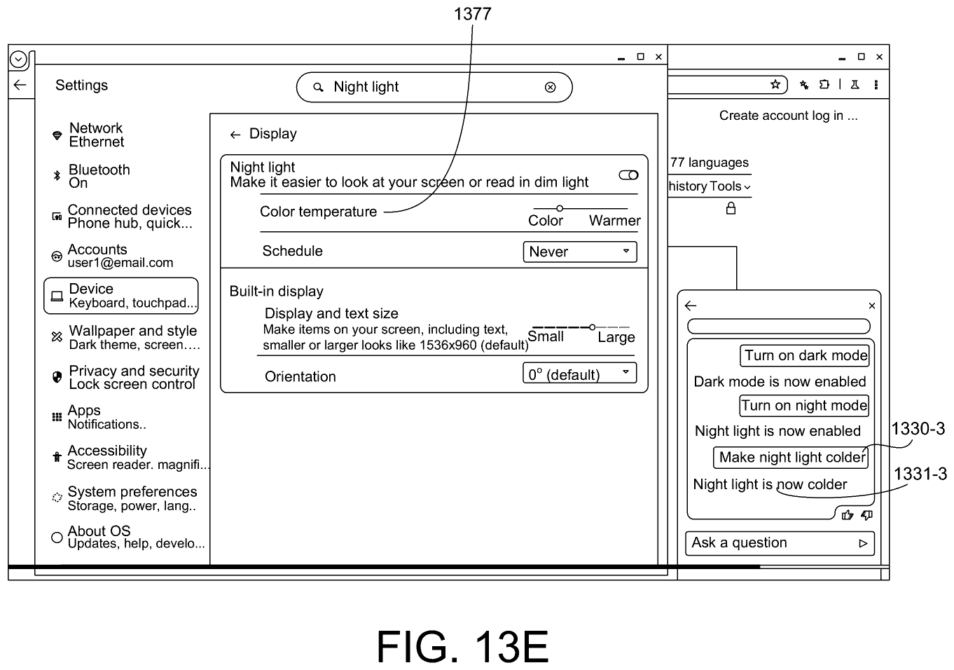

FIGS. 13A to 13E illustrate an example user interface 1370 with an interface 1378 for performing a computer task (e.g., adjusting a setting) according to an aspect. The interface 1378 may be an example of any of the interfaces discussed herein and may include any of the details discussed with reference to the previous figures. Referring to FIG. 13A, a user may submit a natural language query 1330-1 (e.g., “turn on dark mode”) via an input field 1374 of the interface 1378. In response to the natural language query 1330, a task assistant (e.g., the task assistant of any of the previous figures) may communicate with a language model to implement instructions to turn on the dark mode. In response to the dark mode being enabled, the task assistant may provide display content 1331-1 (e.g., “dark mode is now enabled”) on the interface 1328. Referring to FIG. 13C, a user may enter a natural language query 1330-2 (e.g., “turn on night light”), and, in response to the natural language query 1330-2, the task assistant may communicate with a language model to implement instructions to turn on the night light. Referring to FIG. 13D, in response to the dark mode being enabled, the task assistant may provide display content 1331-2 (e.g., “night light is now enabled”) on the interface 1328. Referring to FIG. 13E, a user may enter a natural language query 1330-3 (e.g., “make night light colder”), and, in response to the natural language query 1330-3, the task assistant may communicate with a language model to implement instructions to make the night light colder. In response to the night light being made colder, the task assistant may provide display content 1331-3 (e.g., “night light is now colder”) on the interface 1328.

Clause 1. A computer-implemented method comprising: receiving, via an interface, a natural language query about a request for a user device to perform a computer task; generating a prompt including the natural language query and a list of functions; transmitting the prompt to a language model; receiving a response from the language model, the response including machine-readable instructions executable by the user device to perform the computer task, the machine-readable instructions using at least one function from the list of functions; and executing the machine-readable instructions to perform the computer task.

Clause 2. The computer-implemented method of clause 1, wherein the prompt is a first prompt and the response is a first response, wherein executing the machine-readable instructions includes: performing a step of the computer task by executing a portion of the machine-readable instructions; in response to execution of the portion of the machine-readable instructions, detecting an error message; transmitting, to the language model, a second prompt requesting re-generation of code for the portion of the machine-readable instructions, the second prompt including the error message; receiving, from the language model, a second response that includes replacement code for the step; and executing the replacement code to perform the step.

Clause 3. The computer-implemented method of clause 1, further comprising: in response to successful performance of the computer task, storing the computer task in a memory device; and initiating a display of a user interface element corresponding to the computer task on the interface, wherein the user interface element, when selected, is configured to cause the machine-readable instructions to be re-executed.

Clause 4. The computer-implemented method of clause 1, wherein the list of functions includes a first function and a second function, wherein the prompt is a first prompt, and the response is a first response, wherein executing the machine-readable instructions includes: executing a first portion of the machine-readable instructions including executing the first function; and executing a second portion of the machine-readable instructions, including: transmitting a second prompt to the language model, the second prompt including a first execution result of the first function, the second prompt requesting the language model to execute the second function using the first execution result, and receiving a second response from the language model, the second response including a second execution result of the second function.

Clause 5. The computer-implemented method of clause 4, wherein the first function includes obtaining session state information about a computing session of a user, the session state information identifying a list of session items.

Clause 6. The computer-implemented method of clause 5, wherein the second function includes identifying one or more session items from the list of session items that are semantically related to one or more terms included in the natural language query.

Clause 7. The computer-implemented method of clause 5, wherein the second function includes generating a textual description about a session item from the list of session items.

Clause 8. The computer-implemented method of clause 1, further comprising: generating, by a parser, executable instructions from the machine-readable instructions, wherein the executable instructions are used to execute the computer task.

Clause 9. The computer-implemented method of clause 1, wherein the machine-readable instructions include source code.

Clause 10. A non-transitory computer-readable medium storing instructions that cause at least one processor to execute operations, the operations comprising: receiving, via an interface, a natural language query about a request for a user device to perform a computer task; generating a first prompt including the natural language query and a list of functions; transmitting the first prompt to a language model; receiving a response from the language model, the response including machine-readable instructions executable by the user device to perform the computer task, the machine-readable instructions using a first function and a second function from the list of functions; and executing the machine-readable instructions to perform the computer task, including: executing, in a first step, a first source code portion causing execution of the first function to obtain an execution result; and executing, in a second step, a second source code portion causing transmission of a second prompt that requests the language model to execute the second function on the execution result from the first step.

Clause 11. The non-transitory computer-readable medium of clause 10, wherein the operations further comprise: in response to execution of the first source code portion, detecting an error message; transmitting, to the language model, a third prompt requesting re-generation of code for the first source code portion, the third prompt including the error message; receiving, from the language model, replacement code for the first step; and executing the replacement code to perform the first step.

Clause 12. The non-transitory computer-readable medium of clause 10, wherein the operations further comprise: in response to successful performance of the computer task, storing the computer task in a memory device; and initiating a display of a user interface element corresponding to the computer task on the interface, wherein the user interface element, when selected, is configured to cause the machine-readable instructions to be re-executed.

Clause 13. The non-transitory computer-readable medium of clause 10, wherein the first function includes obtaining session state information about a computing session of a user, the session state information identifying a list of session items.

Clause 14. The non-transitory computer-readable medium of clause 13, wherein the second function includes identifying one or more session items from the list of session items that are semantically related to one or more terms included in the natural language query.

Clause 15. The non-transitory computer-readable medium of clause 13, wherein the second function includes generating a textual description about a session item from the list of session items.

Clause 16. An apparatus comprising: at least one processor; and a non-transitory computer-readable medium storing executable instructions that when executed by the at least one processor cause the at least one processor to: receive, via an interface, a natural language query about a request for a user device to perform a computer task; generate a prompt including the natural language query and a list of functions; transmit the prompt to a language model; receive a response from the language model, the response including machine-readable instructions executable by the user device to perform the computer task, the machine-readable instructions using at least one function from the list of functions; and execute the machine-readable instructions to perform the computer task.

Clause 17. The apparatus of clause 16, wherein the prompt is a first prompt and the response is a first response, wherein the executable instructions cause the at least one processor to: perform a step of the computer task by executing a portion of the machine-readable instructions; in response to execution of the portion of the machine-readable instructions, detect an error message; transmit, to the language model, a second prompt requesting re-generation of code for the portion of the machine-readable instructions, the second prompt including the error message; receive, from the language model, a second response that includes replacement code for the step; and execute the replacement code to perform the step.

Clause 18. The apparatus of clause 16, wherein the executable instructions include instructions that cause the at least one processor to: in response to successful performance of the computer task, store the computer task in a memory device; and initiate a display of a user interface element corresponding to the computer task on the interface, wherein the user interface element, when selected, is configured to cause the machine-readable instructions to be re-executed.

Clause 19. The apparatus of clause 16, wherein the list of functions includes a first function and a second function, wherein the prompt is a first prompt, and the response is a first response, wherein the executable instructions include instructions that cause the at least one processor to: execute a first portion of the machine-readable instructions including executing the first function; and execute a second portion of the machine-readable instructions, including: transmit a second prompt to the language model, the second prompt including a first execution result of the first function, the second prompt requesting the language model to execute the second function using the first execution result; and receive a second response from the language model, the second response including a second execution result of the second function.

Clause 20. The apparatus of clause 19, wherein the first function includes obtaining session state information about a computing session of a user, the session state information identifying a list of session items, and wherein the second function includes identifying one or more session items from the list of session items that are semantically related to one or more terms included in the natural language query or the second function includes generating a textual description about a session item from the list of session items.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are remote from each other and typically interact through a communication network. The relationship of client and server arises by virtue of computer programs running on the respective computers and having a client-server relationship with each other.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the implementations disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, it should be understood that such terms must be correspondingly modified.

Further, in this specification and the appended claims, the singular forms “a,” “an” and “the” do not exclude the plural reference unless the context clearly dictates otherwise. Moreover, conjunctions such as “and,” “or,” and “and/or” are inclusive unless the context clearly dictates otherwise. For example, “A and/or B” includes A alone, B alone, and A with B.

Although certain example methods, apparatuses and articles of manufacture have been described herein, the scope of coverage of this patent is not limited thereto. It is to be understood that terminology employed herein is for the purpose of describing particular aspects and is not intended to be limiting. On the contrary, this patent covers all methods, apparatus and articles of manufacture fairly falling within the scope of the claims of this patent.

What is claimed is:

1. A computer-implemented method comprising:
receiving, via an interface, a natural language query about a request for a user device to perform a computer task;
generating a prompt including the natural language query and a list of functions;
transmitting the prompt to a language model;
receiving a response from the language model, the response including machine-readable instructions executable by the user device to perform the computer task, the machine-readable instructions using at least one function from the list of functions; and
executing the machine-readable instructions to perform the computer task.

2. The computer-implemented method of claim 1, wherein the prompt is a first prompt and the response is a first response, wherein executing the machine-readable instructions includes:
performing a step of the computer task by executing a portion of the machine-readable instructions;
in response to execution of the portion of the machine-readable instructions, detecting an error message;
transmitting, to the language model, a second prompt requesting re-generation of code for the portion of the machine-readable instructions, the second prompt including the error message;
receiving, from the language model, a second response that includes replacement code for the step; and
executing the replacement code to perform the step.

3. The computer-implemented method of claim 1, further comprising:
in response to successful performance of the computer task, storing the computer task in a memory device; and
initiating a display of a user interface element corresponding to the computer task on the interface, wherein the user interface element, when selected, is configured to cause the machine-readable instructions to be re-executed.

4. The computer-implemented method of claim 1, wherein the list of functions includes a first function and a second function, wherein the prompt is a first prompt, and the response is a first response, wherein executing the machine-readable instructions includes:
executing a first portion of the machine-readable instructions including executing the first function; and
executing a second portion of the machine-readable instructions, including:
transmitting a second prompt to the language model, the second prompt including a first execution result of the first function, the second prompt requesting the language model to execute the second function using the first execution result, and
receiving a second response from the language model, the second response including a second execution result of the second function.

5. The computer-implemented method of claim 4, wherein the first function includes obtaining session state information about a computing session of a user, the session state information identifying a list of session items.

6. The computer-implemented method of claim 5, wherein the second function includes identifying one or more session items from the list of session items that are semantically related to one or more terms included in the natural language query.

7. The computer-implemented method of claim 5, wherein the second function includes generating a textual description about a session item from the list of session items.

8. The computer-implemented method of claim 1, further comprising:
generating, by a parser, executable instructions from the machine-readable instructions, wherein the executable instructions are used to execute the computer task.

9. The computer-implemented method of claim 1, wherein the machine-readable instructions include source code.

10. A non-transitory computer-readable medium storing instructions that cause at least one processor to execute operations, the operations comprising:
receiving, via an interface, a natural language query about a request for a user device to perform a computer task;
generating a first prompt including the natural language query and a list of functions;
transmitting the first prompt to a language model;
receiving a response from the language model, the response including machine-readable instructions executable by the user device to perform the computer task, the machine-readable instructions using a first function and a second function from the list of functions; and
executing the machine-readable instructions to perform the computer task, including:
executing, in a first step, a first source code portion causing execution of the first function to obtain an execution result; and
executing, in a second step, a second source code portion causing transmission of a second prompt that requests the language model to execute the second function on the execution result from the first step.

11. The non-transitory computer-readable medium of claim 10, wherein the operations further comprise:
in response to execution of the first source code portion, detecting an error message;
transmitting, to the language model, a third prompt requesting re-generation of code for the first source code portion, the third prompt including the error message;
receiving, from the language model, replacement code for the first step; and
executing the replacement code to perform the first step.

12. The non-transitory computer-readable medium of claim 10, wherein the operations further comprise:
in response to successful performance of the computer task, storing the computer task in a memory device; and
initiating a display of a user interface element corresponding to the computer task on the interface, wherein the user interface element, when selected, is configured to cause the machine-readable instructions to be re-executed.

13. The non-transitory computer-readable medium of claim 10, wherein the first function includes obtaining session state information about a computing session of a user, the session state information identifying a list of session items.

14. The non-transitory computer-readable medium of claim 13, wherein the second function includes identifying one or more session items from the list of session items that are semantically related to one or more terms included in the natural language query.

15. The non-transitory computer-readable medium of claim 13, wherein the second function includes generating a textual description about a session item from the list of session items.

16. An apparatus comprising:
at least one processor; and
a non-transitory computer-readable medium storing executable instructions that when executed by the at least one processor cause the at least one processor to:
receive, via an interface, a natural language query about a request for a user device to perform a computer task;
generate a prompt including the natural language query and a list of functions;
transmit the prompt to a language model;
receive a response from the language model, the response including machine-readable instructions executable by the user device to perform the computer task, the machine-readable instructions using at least one function from the list of functions; and
execute the machine-readable instructions to perform the computer task.

17. The apparatus of claim 16, wherein the prompt is a first prompt and the response is a first response, wherein the executable instructions cause the at least one processor to:
perform a step of the computer task by executing a portion of the machine-readable instructions;
in response to execution of the portion of the machine-readable instructions, detect an error message;
transmit, to the language model, a second prompt requesting re-generation of code for the portion of the machine-readable instructions, the second prompt including the error message;
receive, from the language model, a second response that includes replacement code for the step; and
execute the replacement code to perform the step.

18. The apparatus of claim 16, wherein the executable instructions include instructions that cause the at least one processor to:
in response to successful performance of the computer task, store the computer task in a memory device; and
initiate a display of a user interface element corresponding to the computer task on the interface, wherein the user interface element, when selected, is configured to cause the machine-readable instructions to be re-executed.

19. The apparatus of claim 16, wherein the list of functions includes a first function and a second function, wherein the prompt is a first prompt, and the response is a first response, wherein the executable instructions include instructions that cause the at least one processor to:
execute a first portion of the machine-readable instructions including executing the first function; and
execute a second portion of the machine-readable instructions, including:
transmit a second prompt to the language model, the second prompt including a first execution result of the first function, the second prompt requesting the language model to execute the second function using the first execution result; and
receive a second response from the language model, the second response including a second execution result of the second function.

20. The apparatus of claim 19,
wherein the first function includes obtaining session state information about a computing session of a user, the session state information identifying a list of session items, and
wherein the second function includes identifying one or more session items from the list of session items that are semantically related to one or more terms included in the natural language query or the second function includes generating a textual description about a session item from the list of session items.
